(19) United States
(12) Patent Application Publication
(10) Pub. No.: US 2026/0253351 A1
(43) Pub. Date: Aug. 27, 2026

(54) DEVICE AND METHOD FOR GENERATING SEARCH MODEL, DEVICE AND METHOD FOR TEACHING OPERATION POSITION, AND CONTROL APPARATUS

(71) Applicant: Fanuc Corporation, Minamitsuru-gun, Yamanashi (JP)

(72) Inventor: Takashi YAMAZAKI, Minamitsuru-gun, Yamanashi (JP)

(73) Assignee: Fanuc Corporation, Minamitsuru-gun, Yamanashi (JP)

(21) Appl. No.: 19/162,690

(22) PCT Filed: Mar. 14, 2023
(86) PCT No.: PCT/JP2023/009922

§ 371 Date: Sep. 5, 2025

(51) Int. Cl. G06T 19/20; B25J 9/16; G06T 7/70

(52) U.S. Cl. CPC G06T 19/20; B25J 9/1664; G06T 7/70; G06T 2219/2004; G06T 2219/2016; G06T 2219/2021

(57) ABSTRACT

There is a demand for simplifying an operation for generating a search model since it is necessary to prepare search models of various postures in order to search for a workpiece from image data.

This device for generating a search model for searching for a workpiece from image data obtained by imaging the workpiece includes: an input reception unit for receiving an input of a change amount for changing a posture of a workpiece model, which is obtained by modeling the workpiece, in a virtual space; a simulation unit that changes, as a simulation, the posture of the workpiece model in the virtual space; and a search model generation unit that, when the simulation unit changes the posture, generates, on the basis of the workpiece model, a search model representing the shape of the workpiece model viewed from a prescribed viewpoint in the virtual space.

### CROSS REFERENCE TO RELATED APPLICATIONS

This is the U.S. National Phase application of PCT/JP2023/009922, filed Mar. 14, 2023, the disclosure of this application being incorporated herein by reference in its entirety for all purposes.

### FIELD OF THE INVENTION

The present disclosure relates to a device and method of generating a search model, a device and method of teaching a work position, and a controller.

### BACKGROUND OF THE INVENTION

A device configured to generate a search model for searching for a workpiece from image data and teach a work position on the workpiece is known (e.g., Patent Literature 1).

### PATENT LITERATURE

PTL 1: JP 2018-144161 A

### SUMMARY OF THE INVENTION

In order to search for a workpiece from image data, it is necessary to prepare search models of various orientations, but there is a demand to simplify the work of generating the search model. In addition, it had been necessary to teach the work position to each of the plurality of generated search models, and the work required for teaching had been complicated.

In one aspect of the present disclosure, there is provided a device configured to generate a search model for searching for a workpiece from image data obtained by imaging the workpiece, the device including an input receiving unit configured to receive an input of a change amount for changing an orientation of a workpiece model modeling the workpiece in a virtual space, a simulating unit configured to simulatively change the orientation of the workpiece model in the virtual space in accordance with the change amount received by the input receiving unit, and a search model generating unit configured to generate, based on the workpiece model, the search model representing a shape of the workpiece model as viewed from a predetermined viewpoint in the virtual space, when the simulating unit changes the orientation.

In another aspect of the present disclosure, there is provided a method of generating a search model for searching for a workpiece from image data obtained by imaging the workpiece, the method including: receiving, by a processor, an input of a change amount for changing an orientation of a workpiece model modeling the workpiece in a virtual space; simulatively changing, by the processor, an orientation of the workpiece model in the virtual space in accordance with the received change amount; and generating, by the processor, the search model representing a shape of the workpiece model as viewed from a predetermined viewpoint in the virtual space, based on the workpiece model when the orientation is changed.

In another further aspect of the present disclosure, there is provided a device configured to teach a work position at which a robot carries out a work on a workpiece, the device including: an input receiving unit configured to receive an input for teaching the work position on a workpiece model modeling an overall shape of the workpiece; and a position recording unit configured to record the work position, which is taught in response to the input received by the input receiving unit, in association with the workpiece model, as a teaching position indicating a positional relationship between the workpiece model and the work position, wherein the work position on the workpiece searched from image data by a search model generated based on the workpiece model is to be calculated using the recording teaching position.

In another further aspect of the present disclosure, there is provided a method of teaching a work position at which a robot carries out work on a workpiece, the method including: receiving, by a processing, an input for teaching the work position on a workpiece model modeling an overall shape of the workpiece; recording, by the processing, the work position, which is taught in response to the received input, in association with the workpiece model, as a teaching position indicating a positional relationship between the workpiece model and the work position; and using, by the processing, the recorded teaching position to calculate the work position on the workpiece searched from the image data by a search model generated based on the workpiece model.

### BRIEF DESCRIPTION OF DRAWINGS

FIG. 1 is a schematic view of a robot system according to one embodiment.

FIG. 2 is a block diagram of the robot system illustrated in FIG. 1.

FIG. 3 illustrates a workpiece according to one embodiment and a workpiece model of the workpiece.

FIG. 4 illustrates an example of teaching setting image data.

FIG. 5 illustrates an example of image data of a virtual space in which a robot model and a workpiece model are arranged.

FIG. 6 illustrates a state in which the end effector model is moved in the virtual space illustrated in FIG. 5.

FIG. 7 illustrates an example of a rotation cursor image.

FIG. 8 illustrates a state in which the end effector model is moved in the virtual space illustrated in FIG. 5.

FIG. 9 is a block diagram illustrating other functions of the robot system.

FIG. 10 illustrates an example of search model setting image data.

FIG. 11 is a diagram when the workpiece model illustrated in FIG. 3 is viewed from a viewpoint VP.

FIG. 12 illustrates a search model generated based on the workpiece model illustrated in FIG. 11.

FIG. 13 is a block diagram illustrating other functions of the robot system.

FIG. 14 is a flowchart illustrating an example of an operation flow of the robot system of FIG. 13.

FIG. 15 illustrates an example of image data imaged in step S2 in FIG. 14.

FIG. 16 illustrates a state in which the search model is matched with the image data illustrated in FIG. 15.

FIG. 17 illustrates an example of a data structure of list data generated in step S5 in FIG. 14.

FIG. 18 illustrates list data in which target positions are rearranged in accordance with the priority order illustrated in FIG. 17.

FIG. 19 illustrates list data in which target positions illustrated in FIG. 18 are further rearranged in accordance with a predetermined condition.

FIG. 20 illustrates an example of a flow of step S6 in FIG. 14.

FIG. 21 is a block diagram illustrating other further functions of the robot system.

FIG. 22 illustrates another example of the flow of step S6 in FIG. 14.

FIG. 23 is a diagram for explaining step S31 in FIG. 22.

FIG. 24 is a schematic diagram of a controller according to another embodiment.

FIG. 25 is a block diagram of the controller illustrated in FIG. 24.

### DESCRIPTION OF EMBODIMENTS OF THE INVENTION

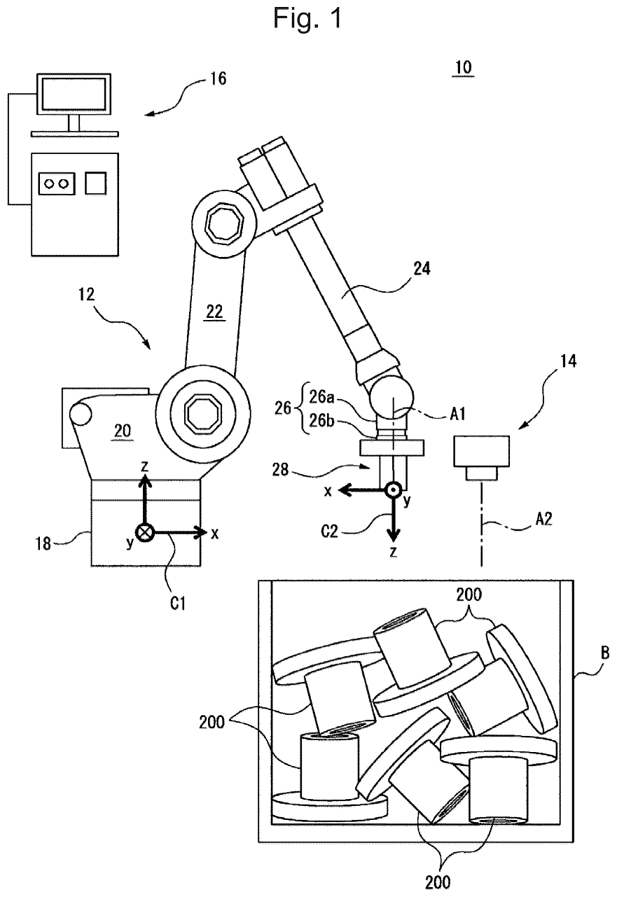

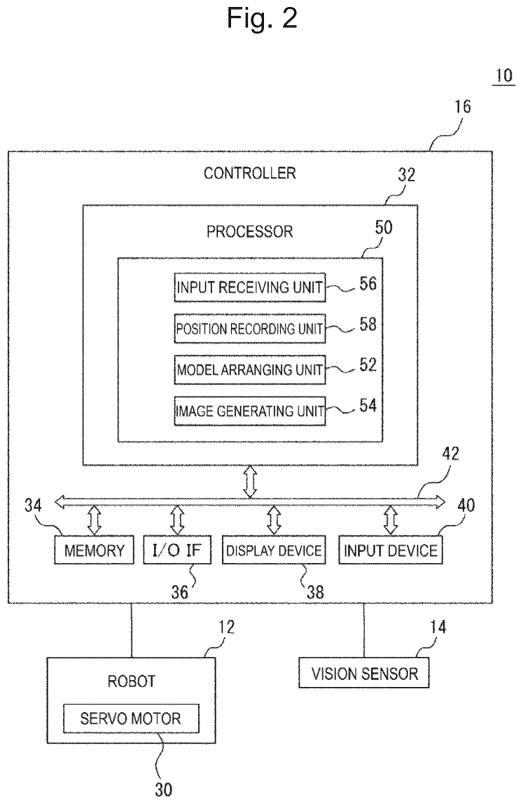

Embodiments of the present disclosure are described in detail below with reference to the drawings. Note that in various embodiments described below, the same elements are denoted with the same reference numerals, and overlapping description is omitted. First, a robot system 10 according to an embodiment will be described with reference to FIG. 1 and FIG. 2. The robot system 10 includes a robot 12, a vision sensor 14, and a controller 16.

In the present embodiment, the robot 12 is a vertical articulated robot and includes a robot base 18, a revolving body 20, a lower arm 22, an upper arm 24, a wrist 26, and an end effector 28. The robot base 18 is fixed on a floor of a work cell or on an automated guided vehicle (AGV). The revolving body 20 is provided on the robot base 18 so as to be able to revolve about the vertical axis.

The lower arm 22 has a basal end part provided on the revolving body 20 so as to be turnable about the horizontal axis, and the upper arm 24 has a basal end part provided at the distal end part of the lower arm 22 so as to be turnable. The wrist 26 includes a wrist base 26a provided at the distal end part of the upper arm 24 so as to be turnable about two axes orthogonal to each other, and a wrist flange 26b provided at the wrist base 26a so as to be turnable about a wrist axis A1.

The end effector 28 is removably attached to the wrist flange 26b. The end effector 28 may be, for example, a robot hand capable of gripping a workpiece 200, a welding torch for welding the workpiece 200, a laser processing head for subjecting the workpiece 200 to laser processing, or the like, and carries out a predetermined work (workpiece handling, welding, or laser processing) on the workpiece 200.

Each of the components of the robot 12 (the robot base 18, the revolving body 20, the lower arm 22, the upper arm 24, and the wrist 26) is provided with a servomotor 30 (FIG. 2). These servomotors 30 turn the drive shafts of the robot 12 in response to a command from the controller 16. As a result, the robot 12 can move the end effector 28 to be arranged at a freely-selected position.

As illustrated in FIG. 1, a robot coordinate system C1 and a tool coordinate system C2 are set for the robot 12. The robot coordinate system C1 is a control coordinate system C for controlling the operation of each movable component (i.e., the revolving body 20, the lower arm 22, the upper arm 24, the wrist base 26a, the wrist 26, and the end effector 28) of the robot 12. In the present embodiment, the robot coordinate system C1 is fixed to the robot base 18, with its origin disposed at the center of the robot base 18 and with the z-axis thereof set parallel to (specifically, coinciding with) the revolving axis of the revolving body 20.

On the other hand, the tool coordinate system C2 is a control coordinate system C that determines the position of the end effector 28 in the robot coordinate system C1 in order to control the robot 12 at the time of work. In the present embodiment, the tool coordinate system C2 is set with respect to the end effector 28 such that the origin (so-called TCP) is disposed at a work position (i.e., a workpiece gripping position, a welding position, or a laser beam emission port) of the end effector 28 and with the z-axis thereof is set parallel to (specifically, coinciding with) the wrist axis Al.

When moving the end effector 28, the controller 16 sets the tool coordinate system C2 in the robot coordinate system C1, and generates a command for each of the servo motors 30 of the robot 12 so as to position the end effector 28 at a position represented by the set tool coordinate system C2. In this way, the controller 16 can position the end effector 28 at an arbitrary position in the robot coordinate system C1. In the present description, “position” may indicate a position and an orientation.

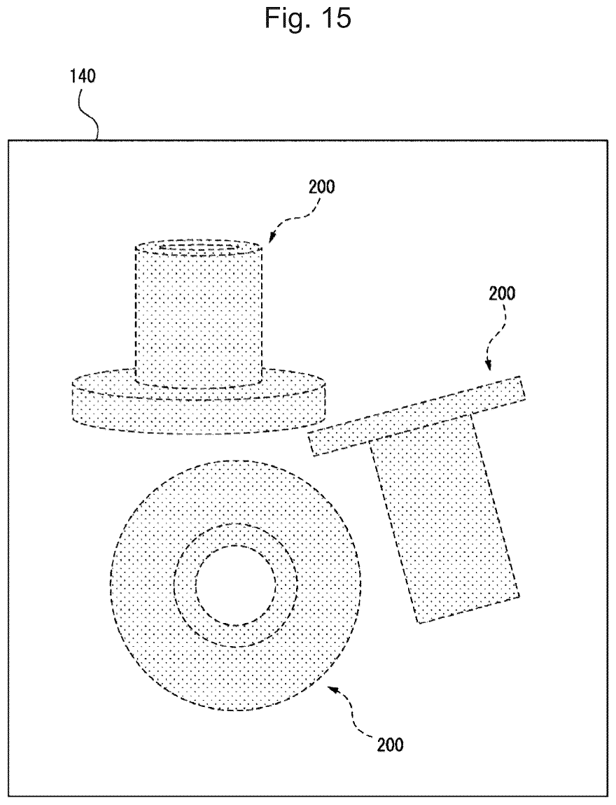

The vision sensor 14 images image data 140 (FIG. 15) of the workpiece 200. In the present embodiment, the vision sensor 14 is, for example, a three-dimensional vision sensor including an imaging sensor (CMOS, CCD, etc.) and an optical lens (a collimator lens, a focus lens, etc.) that guides a subject image to the imaging sensor. The vision sensor 14 may be fixed with respect to a movable component of the robot (e.g., the end effector 28 or the wrist flange 26b) and moved by the robot 12.

Alternatively, the vision sensor 14 may be fixed-point fixed at a position where the workpiece 200 can be fitted in the field of view. The vision sensor 14 is configured to image a subject (i.e., the workpiece 200) along an optical axis A2 and measure a distance d to the subject. The vision sensor 14 supplies the imaged image data 140 to the controller 16.

The controller 16 controls the operation of the robot 12 and the vision sensor 14. As illustrated in FIG. 2, the controller 16 is a computer including a processor 32, a memory 34, an I/O interface 36, a display device 38, and an input device 40. The processor 32 includes a CPU or a GPU, is communicably connected to the memory 34, the I/O interface 36, the display device 38, and the input device 40 via a bus 42, and performs arithmetic processing to achieve various types of functions described below while communicating with these components.

The memory 34 includes a RAM, a ROM, and the like and temporarily or permanently records various types of data. The memory 34 may include a non-transitory computer-readable storage medium, such as a volatile memory, a non-volatile memory, a magnetic storage medium, or an optical storage medium. The I/O interface 36 includes, for example, an Ethernet (registered trademark) port, a USB port, an optical fiber connector, or an HDMI (registered trademark) terminal, and communicates data with external devices by wire or wirelessly under a command from the processor 32. Each servomotor 30 of the robot 12 and the vision sensor 14 are communicably connected to the I/O interface 36.

The display device 38 includes a liquid crystal display, an organic EL display, or the like, and displays various types of data in a visually recognizable manner under a command from the processor 32. The input device 40 includes a push button, a switch, a keyboard, a mouse, a touchscreen, or the like and receives data input from an operator. Note that the display device 38 and the input device 40 may be integrally incorporated in a housing of the controller 16, or may be connected to the I/O interface 36 as one computer (PC etc.) separate from the housing of the controller 16.

Hereinafter, a case where the end effector 28 is a robot hand, and the processor 32 performs workpiece handling of gripping and picking up the workpieces 200 stacked in bulk in a container B at a predetermined work position Pw (i.e., the gripping position) by the end effector 28 as a predetermined work to be executed by the robot 12 will be described.

In order to build the operation program OP for executing this work (i.e., workpiece handling), the operator carries out a work of setting various parameters of the operation program OP. The operation program OP includes a computer program such as a detection program OP1 that performs image processing on the image data 140 of the workpiece 200 and detects the workpiece 200 shown in the image data 140. Specifically, the operator executes a teaching process of teaching a work position Pw (gripping position) at which a work (workpiece handling) is carried out on the workpiece 200.

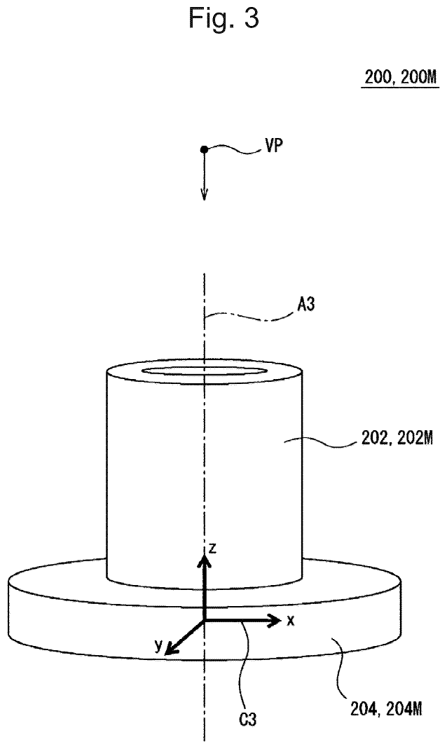

FIG. 3 illustrates an example of the workpiece 200 to be a work target. In the present embodiment, the workpiece 200 is a cylindrical member having a central axis A3, and includes a shaft 202 and a flange 204. The workpiece 200 has an overall shape that is rotationally symmetric with respect to the central axis A3. For the teaching process, the operator creates a workpiece model 200M modeling the overall shape of the workpiece 200. The workpiece model 200M is, for example, a three-dimensional CAD model, and is created by an operator using a CAD device (not illustrated).

Note that in the following description, a model of a certain member XX (e.g., the robot 12) will be referred to as a member model XXM (robot model 12M). Therefore, the workpiece model 200M has a shaft model 202M and a flange model 204M. The workpiece model 200M represents the overall shape (i.e., all surfaces, edges, etc. of the workpiece 200) of the workpiece 200. As illustrated in FIG. 3, a workpiece coordinate system C3 is set in the workpiece model 200M.

The workpiece coordinate system C3 is a control coordinate system C that determines a position in the robot coordinate system C1 of the workpiece 200 of the work target in order to control the robot 12 at the time of work. In the present embodiment, the workpiece coordinate system C3 is set with respect to the workpiece model 200M such that the origin thereof is arranged at the center of gravity of the workpiece model 200M (i.e., the workpiece 200) and the z-axis thereof is parallel to (specifically, coinciding with) the central axis A3. Note that the origin of the workpiece coordinate system C3 may be a CAD origin that is used as a reference when the workpiece model 200M is created by the CAD device.

The workpiece model 200M created by the CAD device is downloaded to the controller 16 and recorded in the memory 34. Specifying information Is (e.g., a character or a symbol representing a model name, a file name, or an identification code) for specifying the workpiece model 200M is attached to the data (or the data file) of the workpiece model 200M.

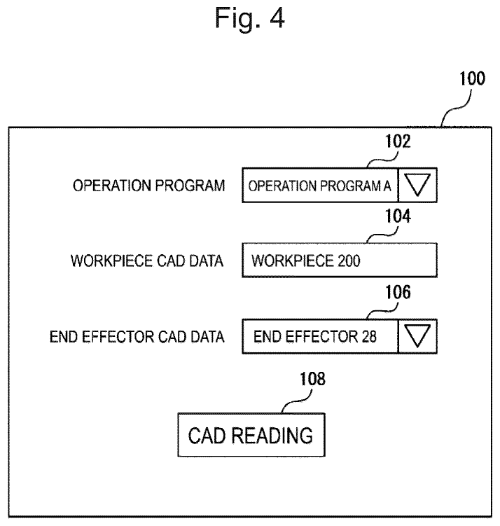

After the start of the teaching process, the processor 32 generates teaching setting image data 100 illustrated in FIG. 4 and displays the same on the display device 38. The teaching setting image data 100 is a graphical user interface (GUI) for selecting the operation program OP for executing the work and the end effector of the robot 12. Specifically, the teaching setting image data 100 includes a program selection image 102, a workpiece information image 104, an end effector selection image 106, and a model reading button image 108.

The program selection image 102 is a GUI for selecting an operation program OP used for work from among a plurality of operation programs OP prepared in advance. For example, when the operator clicks the program selection image 102 on the image by operating the input device 40, a list (e.g., a list of program names, program identification codes, etc.) of various operation programs OP recorded in the memory 34 is displayed.

The operator can select the operation program OP to be used at the time of work from the displayed operation program OP. Hereinafter, a case in which the operation program OP_{A} (“operation program A” illustrated in FIG. 4) is selected from the various operation programs OP and the parameters of the operation program OPA are set will be described.

The workpiece information image 104 displays a workpiece model registered in association with the operation program OPA selected in the program selection image 102. In the example illustrated in FIG. 4, an example in which the workpiece 200 illustrated in FIG. 3 is registered in association with the operation program OP_{A} is exemplified. On the other hand, the end effector selection image 106 is a GUI for selecting an end effector to be used for the actual work from a plurality of types of end effectors prepared in advance.

For example, when the operator operates clicks the end effector selection image 106 on the image by operating the input device 40, a list (e.g., a list of model names, model numbers, identification codes, etc.) of various types of end effectors recorded in the memory 34 is displayed. The operator can select an end effector to be used at the time of work from among the displayed various end effectors. Hereinafter, a case where the end effector 28 illustrated in FIG. 1 is selected as the end effector will be described.

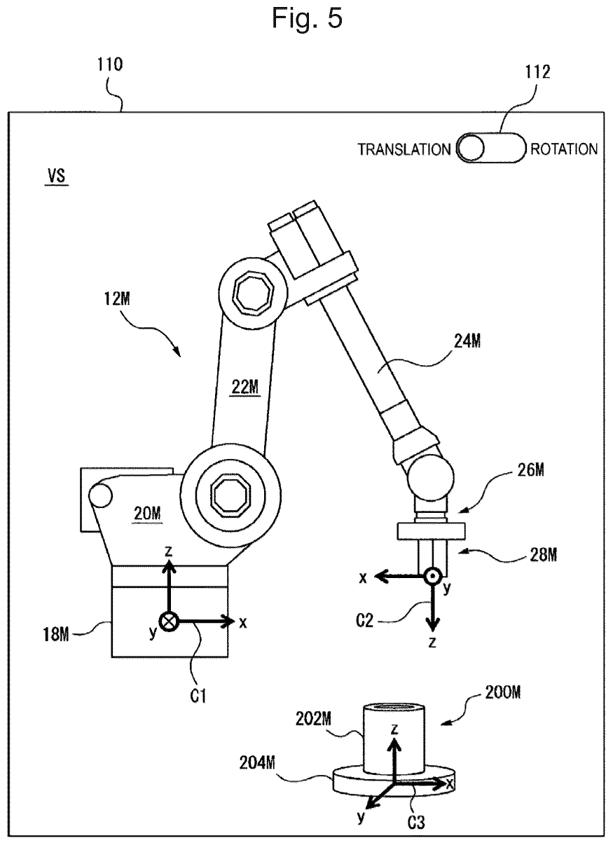

The model reading button image 108 is a GUI for reading the workpiece model 200M, the robot model 12M modeling the robot 12, and the control coordinate system C and arranging them at the virtual space VS for teaching the work position Pw. When receiving an input for clicking the model reading button image 108 from the operator through the input device 40, the processor 32 arranges the workpiece model 200M and the robot model 12M at the virtual space VS (FIG. 5) together with the robot coordinate system C1, the tool coordinate system C2, and the workpiece coordinate system C3 serving as the control coordinate system C.

The processor 32 arranges the workpiece model 200M registered in association with the operation program OP_{A} selected in the program selection image 102 and the robot model 12M including the end effector model 28M of the end effector 28 selected in the end effector selection image 106 at the virtual space VS together with the robot coordinate system C1, the tool coordinate system C2, and the workpiece coordinate system C3.

In the virtual space VS, the processor 32 sets the robot coordinate system C1 to the robot base model 18M and sets the tool coordinate system C2 to the end effector model 28M, similarly to the robot 12 of the actual machine. Note that the processor 32 may arrange only the end effector model 28M selected in the end effector selection image 106 at the virtual space VS, and need not arrange the robot base model 18M, the revolving body model 20M, the lower arm model 22M, the upper arm model 24M, and the wrist model 26M at the virtual space VS. Furthermore, the processor 32 (model arranging unit 52) refers to the setting information of the workpiece coordinate system C3 registered in association with the workpiece model 200M, and sets the workpiece coordinate system C3 in the workpiece model 200M. For example, the origin of the workpiece coordinate system C3 is set to be arranged at the center of gravity (or the CAD origin) of the workpiece model 200M.

As described above, in the present embodiment, the processor 32 functions as the model arranging unit 52 (FIG. 2) configured to arrange the workpiece model 200M, the robot model 12M, and the control coordinate system C (specifically, the robot coordinate system C1, the tool coordinate system C2, and the workpiece coordinate system C3) at the virtual space VS. Note that when the workpiece model 200M is arranged at the virtual space VS, the processor 32 (model arranging unit 52) may automatically calculate the origin of the workpiece coordinate system C3 as the center of gravity (or, the CAD origin) of the workpiece model 200M and subsequently arrange the workpiece coordinate system C3 at the virtual space VS.

Next, the processor 32 generates image data 110 of the virtual space VS in which the workpiece model 200M, the robot model 12M, and the control coordinate system C (robot coordinate system C1, tool coordinate system C2) are arranged, and displays the image data on the display device 38. An example of the image data 110 is illustrated in FIG. 5. As described above, in the present embodiment, the processor 32 functions as the image generating unit 54 (FIG. 2) configured to generate the image data 110 of the virtual space VS.

In the present embodiment, the operator operates the input device 40 to teach the work position Pw to the workpiece model 12M while simulatively moving the robot model 200M in the virtual space VS. The processor 32 receives an input F for teaching the work position Pw to the workpiece model 200M in the virtual space VS.

Specifically, the processor 32 receives, as the input F, an input Fm for simulatively moving the robot model 12M and the control coordinate system C (robot coordinate system C1, tool coordinate system C2, workpiece coordinate system C3) in the virtual space VS. Here, the processor 32 functions as the image generating unit 54, and further displays a movement selection button image 112 in the image data 110.

The movement selection button image 112 is a GUI for selecting whether or not to translationally move or rotationally move the end effector model 28M in the virtual space VS together with the tool coordinate system C2. The operator can select translational movement or rotational movement by operating the input device 40 and clicking the movement selection button image 112 on the image.

In the image data 110 illustrated in FIG. 5, “translational movement” is selected. In this case, the operator can operate the input device 40 to simulatively translationally move the robot model 12M (specifically, the end effector model 28M) and the tool coordinate system C2 in the virtual space VS. When “translational movement” is selected by the movement selection button image 112, the processor 32 can receive the input Fmₜ for translationally moving the end effector model 28M and the tool coordinate system C2 in the virtual space VS.

As an example, in order to translationally move the end effector model 28M and the tool coordinate system C2, the operator operates the input device 40 to give an input Fmₜ₁ of dragging and dropping the end effector model 28M (or the tool coordinate system C2) in the virtual space VS. The processor 32 receives the input Fmₜ₁ and simulatively operates the movable component models (specifically, the revolving body model 20M, the lower arm model 22M, the upper arm model 24M, and the wrist model 26M) of the robot model 12M in the virtual space VS to translationally move the end effector model 28M and the tool coordinate system C2 in the virtual space VS.

As another example, the operator gives an input Fmₜ₂ that designates a displacement amount δ by which the end effector model 28M (i.e., the origin of the tool coordinate system C2) is displaced in the virtual space VS. For example, the operator may input a displacement amount δx in the x-axis direction, a displacement amount δy in the y-axis direction, and a displacement amount δz in the z-axis direction of the robot coordinate system C1 as the displacement amount δ. The processor 32 receives the input Fmₜ₂ and translationally moves the end effector model 28M and the tool coordinate system C2 by the displacement amount δ (δx, δy, δz) in the virtual space VS.

As still another example, the operator gives an input Fmₜ₃ designating the coordinates Q (x, y, z) of the origin of the tool coordinate system C2 in the robot coordinate system C1. The processor 32 receives the input Fmₜ₃, and translationally moves the end effector model 28M and the tool coordinate system C2 to the position of the coordinates Q (x, y, z) in the virtual space VS. Note that the processor 32 may function as the image generating unit 54 and may further display an image for inputting the displacement amount δ or the coordinate Q described above in the image data 110.

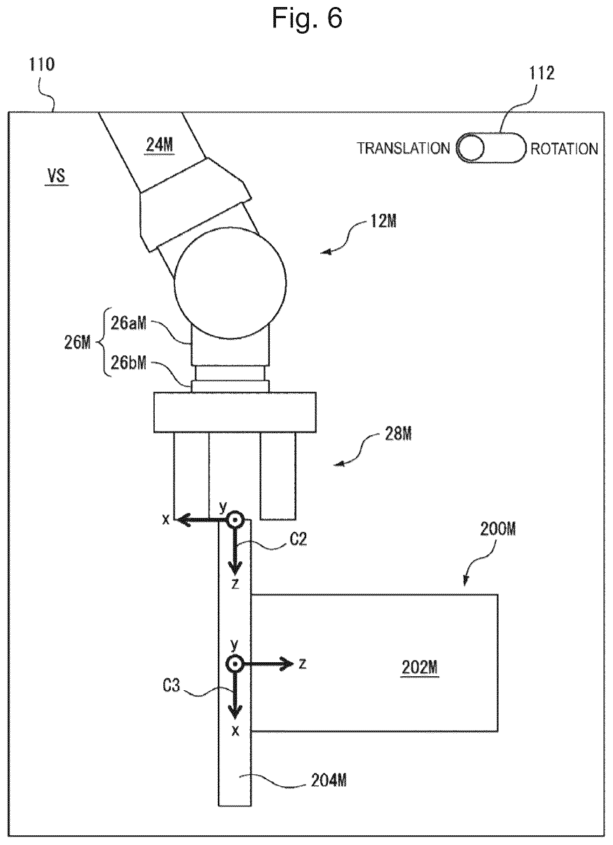

In this way, the processor 32 receives the input Fmₜ₃ for translational movement from the operator, and simulatively translationally moves the end effector model 28M and the tool coordinate system C2 in the virtual space VS. At this time, the orientation of the end effector model 28M does not change. In addition, while the origin of the tool coordinate system C2 is displaced along with the translational movement of the end effector model 28M, each axis direction of the tool coordinate system C2 does not change. With this translational movement, as illustrated in FIG. 6, the end effector model 28M and the tool coordinate system C2 can be arranged at desired positions on the workpiece model 200M.

On the other hand, when the operator click operates the movement selection button image 112 to select “rotational movement”, the processor 32 can receive the input Fmᵣ for rotationally moving the end effector model 28M and the tool coordinate system C2 in the virtual space VS. In the present embodiment, when “rotational movement” is selected, the processor 32 functions as the image generating unit 54 and displays the rotation cursor image 114 in the image data 110 so as to be superimposed on the tool coordinate system C2.

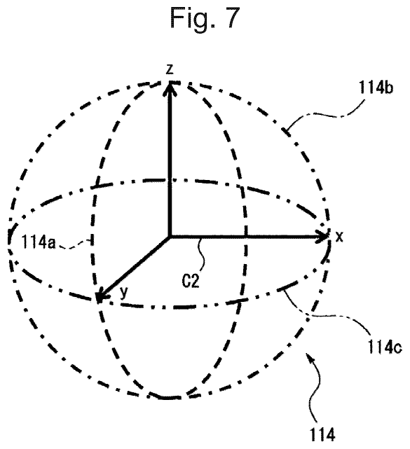

An example of the rotation cursor image 114 is illustrated in FIG. 7. The rotation cursor image 114 is a GUI for designating a direction to rotationally move the end effector model 28M and the tool coordinate system C2 in the virtual space VS. Specifically, the rotation cursor image 114 includes an x axis rotation ring 114a, a y axis rotation ring 114b, and a z axis rotation ring 114c. The x axis rotation ring 114a is a GUI for rotationally moving the end effector model 28M and the tool coordinate system C2 about the x axis of the tool coordinate system C2 before the movement.

When the operator operates the input device 40 to give an input Fmᵣ₁ of operating (clicking or dragging and dropping) the x axis rotation ring 114a on the image, the processor 32 receives the input Fmᵣ₁ and rotates the end effector model 28M and the tool coordinate system C2 about the x axis of the tool coordinate system C2 before the movement in the virtual space VS. On the other hand, when the operator gives an input Fmᵣ₂ of operating the y axis rotation ring 114b on the image, the processor 32 receives the input Fmᵣ₂ and rotates the end effector model 28M and the tool coordinate system C2 about the y axis of the tool coordinate system C2 before the movement.

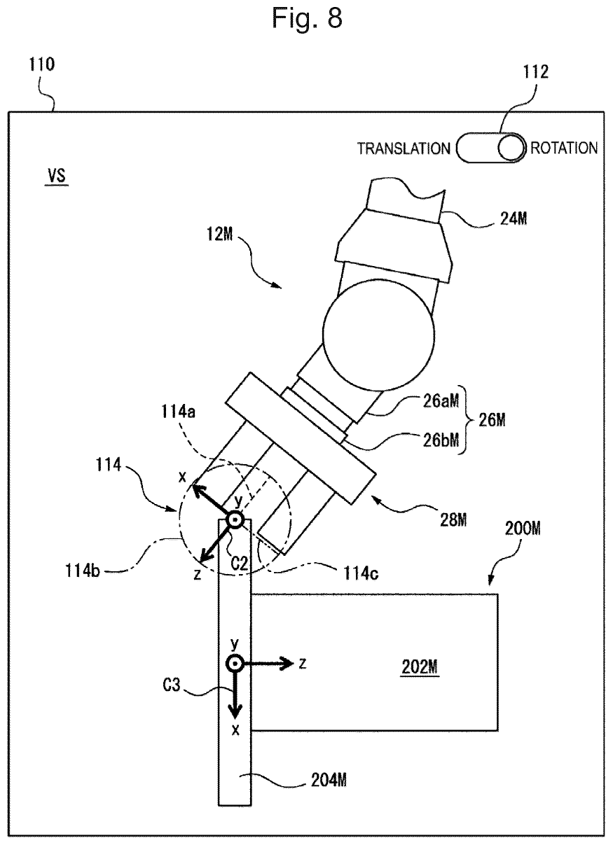

When the operator gives an input Fmᵣ₃ of operating the z axis rotation ring 114c on the image, the processor 32 receives the input Fmᵣ₃ and rotates the end effector model 28M and the tool coordinate system C2 about the z axis of the tool coordinate system C2 before the movement. According to such rotational movement, as illustrated in FIG. 8, the orientations of the end effector model 28M and the tool coordinate system C2 can be arbitrarily changed with respect to the workpiece model 200M. This rotational movement changes the orientation of the end effector model 28M, but does not displace the position of the end effector model 28M. In addition, with the rotational movement of the end effector model 28M, the direction of each axis of the tool coordinate system C2 changes but the origin position is not displaced

The operator can arrange the end effector model 28M and the tool coordinate system C2 at a desired work position Pw on the workpiece model 200M by simulatively moving the end effector model 28M and the tool coordinate system C2 at the virtual space VS as described above. Subsequently, the operator operates the input device 40 to provide an input Fr for recording the work position Pw. When receiving the input Fr, the processor 32 records the work position Pw in the memory 34.

In this way, the work position Pw is taught on the workpiece model 200M. As described above, in the present embodiment, the processor 32 receives the input F (the inputs Fm and Fr) for teaching the work position Pw from the operator, and teaches the work position Pw to the workpiece model 200M in response to the input F. Therefore, the processor 32 functions as an input receiving unit 56 (FIG. 2) configured to receive the input F for teaching the work position Pw.

Upon receiving the input Fr from the operator, the processor 32 acquires the coordinates Qw (x_{w}, y_{w}, z_{w}, w_{w}, p_{w}, r_{w}) in the workpiece coordinate system C3 of the tool coordinate system C2 at this time point. The coordinate Qw is data that represents the work position Pw (in other words, the position and the orientation of the end effector 28 at the time of executing the work) taught on the workpiece model 200M, and indicates the positional relationship between the workpiece model 200M (the workpiece coordinate system C3) and the work position Pw. More specifically, among the coordinate Qw, the coordinates (x_{w}, y_{w}, z_{w}) represent the position of the tool coordinate system C2 (i.e., the end effector model 28M) with respect to the workpiece coordinate system C3 (i.e., the workpiece model 200M), and the coordinates (w_{w}, p_{w}, r_{w}) represent the orientation (so-called yaw, pitch, and roll) of the tool coordinate system C2 with respect to the workpiece coordinate system C3.

The processor 32 records the acquired coordinate Qw in the memory 34 as the teaching position Pwₜ indicating the positional relationship between the workpiece model 200M and the work position Pw. Here, in the present embodiment, the processor 32 records the data of the teaching position Pwₜ in the memory 34 in association with the workpiece model 200M (e.g., the specifying information Is). In this manner, the teaching position Pwₜ and the workpiece model 200M are associated with each other.

At the time of actual work, the processor 32 obtains the work position Pw on the workpiece 200 by calculation using the teaching position Pwₜ recorded as described above. In the actual work, the processor 32 searches for, from the image data 140 (FIG. 15) obtained by the vision sensor 14 imaging the workpiece 200, the workpiece 200 shown in the image data 140 using the search model 200S generated based on the workpiece model 200M. Note that the search model 200S will be described later.

In this way, in the present embodiment, the processor 32 functions as a position recording unit 58 (FIG. 2) configured to record the work position Pw taught on the workpiece model 200M as the teaching position Pwₜ (specifically, the coordinates Qw) in association with the workpiece model 200M. Note that the processor 32 may generate the database DB for the teaching position Pwₜ and record the data (coordinates Qw) of the acquired teaching position Pwₜ in the database DB. The database DB can be recorded in the memory 34 in association with the workpiece model 200M (specifying information Is). As a result of such a teaching process, the information of the end effector 28 (end effector model 28M) used for the actual work and the data (coordinates Qw) of the taught teaching position Pwₜ are registered.

As described above, in the present embodiment, the processor 32 functions as the model arranging unit 52, the image generating unit 54, the input receiving unit 56, and the position recording unit 58, and teaches the work position Pw. Therefore, the model arranging unit 52, the image generating unit 54, the input receiving unit 56, and the position recording unit 58 constitute a device 50 (FIG. 2) configured to teach the work position Pw.

In the device 50, the input receiving unit 56 receives the input F (Fm, Fr) for teaching the work position Pw to the workpiece model 200M, and the position recording unit 58 records the work position Pw taught in response to the input F in association with the workpiece model 200M as the teaching position Pwₜ (coordinates Qw) indicating the positional relationship between the workpiece model 200M (or the workpiece coordinate system C3) and the work position Pw. Subsequently, in actual work, the work position Pw on the workpiece 200 searched for from the image data 140 by the search model 200S is calculated using the teaching position Pwₜ recorded in this way.

According to this configuration, since the operator can teach the work position Pw (teaching position Pwₜ) not to the search model 200S but to the workpiece model 200M, it is not necessary to teach the work position Pw to the search model 200S every time the search model 200S to be described later is generated. Therefore, even when the search models 200S having a plurality of orientations are generated, the work position Pw can be shared among these search models 200S. Thus, the work of teaching the work position Pw can be greatly simplified.

Furthermore, in the device 50, the model arranging unit 52 arranges at least one of the robot model 12M and the control coordinate system C (robot coordinate system C1, tool coordinate system C2, and workpiece coordinate system C3) and the workpiece model 200M at the virtual space VS, and the image generating unit 54 generates the image data 110 of the virtual space VS (FIG. 5). Subsequently, the input receiving unit 56 receives an input Fm for simulatively moving the robot model 12M or the control coordinate system C in the virtual space VS as the input F for teaching. According to this configuration, the operator can easily teach the desired work position Pw by simulatively operating the robot model 12M (specifically, the end effector model 28M) or the control coordinate system C (specifically, the tool coordinate system C2) while visually recognizing the image data 110 of the virtual space VS.

Furthermore, in the device 50, the input receiving unit 56 receives, as the input Fm, an input Fmₜ (Fmₜ₁, Fmₜ₂, Fmₜ₃) for translationally moving the end effector model 28M such that the origin of the tool coordinate system C2 is displaced, or an input Fmᵣ (Fmᵣ₁, Fmᵣ₂, Fmᵣ₃) for rotationally moving the end effector model 28M about the axes (x axis, y axis, or z axis) of the tool coordinate system C2. According to this configuration, the operator can more variously operate the end effector model 28M together with the tool coordinate system C2 in the virtual space VS with a simple operation.

Furthermore, in the device 50, the image generating unit 54 further displays a movement selection button image 112 for selecting translational movement or rotational movement in the image data 110. When translational movement is selected by the movement selection button image 112, the input receiving unit 56 can receive the input Fmₜ for translational movement, and when rotational movement is selected by the movement selection button image 112, the input receiving unit can receive the input Fm, for rotational movement. According to this configuration, the operability of the end effector model 28M and the tool coordinate system C2 in the virtual space VS by the operator can be further improved.

Note that in the above-described teaching process, the operator may teach a plurality of work positions Pw₁, Pw₂, . . . , and Pwₘ to one workpiece model 200M. In this case, the processor 32 functions as the input receiving unit 56 in the teaching process and receives the input F (Fm, Fr) for teaching the plurality of work positions Pwₘ. Subsequently, the processor 32 functions as the position recording unit 58 to record the plurality of teaching positions Pwₜ₁, Pwₜ₂, Pwₜₘ (i.e., coordinates Qw₁ (x_{w1}, y_{w1}, z_{w1}, w_{w1}, p_{w1}, r_{w1}), Qw₂ (x_{w2}, y_{w2}, z_{w2}, w_{w2}, p_{w2}, r_{w2}), . . . Qwₘ (x_{wm}, y_{wm}, z_{wm}, w_{wm}, p_{wm}, r_{wm})) in the memory 34 in association with the workpiece model 200M.

In this case, the processor 32 may function as the input receiving unit 56 to further receive the input G for determining the priority order of the plurality of taught work positions Pwₜₘ (m=1, 2, 3, . . . ). For example, after the teaching position Pwₜₘ is recorded, the operator operates the input device 40 to give an input for giving the priority order indicated by the label information of “high priority”, “medium priority”, or “low priority” to each of the recorded teaching positions Pwₜₘ. The processor 32 records the label information indicating the priority order accompanying the teaching position Pwₜₘ recorded in the memory 34. Accordingly, the operator can give a desired priority order to the plurality of work positions Pwₜₘ (i.e., the plurality of teaching positions Pwₜₘ).

Note that, in the above-described embodiment, the case where the processor 32 functions as the model arranging unit 52 and arranges the robot model 12M, and the robot coordinate system C1, the tool coordinate system C2, and the workpiece coordinate system C3 as the control coordinate system C at the virtual space VS together with the workpiece model 200M has been described. However, the present invention is not limited thereto, and the processor 32 need not arrange the robot model 12M or the control coordinate system C at the virtual space VS.

For example, the processor 32 may arrange only the tool coordinate system C2 serving as the control coordinate system C at the virtual space VS. In this case, the processor 32 functions as the image generating unit 54 and generates the image data 110 of the virtual space VS in which only the tool coordinate system C2 is arranged. In addition, the processor 32 functions as the input receiving unit 56 and receives the input Fm for simulatively moving the tool coordinate system C2 in the virtual space VS from the operator.

Alternatively, the processor 32 may function as the model arranging unit 52 and arrange only the robot model 12M (e.g., the end effector model 28M) at the virtual space VS without arranging the control coordinate system C at the virtual space VS. In this case, the processor 32 generates, as the image generating unit 54, the image data 110 of the virtual space VS in which only the robot model 12M (end effector model 28M) is arranged.

In this way, the processor 32 (model arranging unit 52) arranges at least one of the robot model 12M and the control coordinate system C and the workpiece model 200M at the virtual space VS. Note that the processor 32 may arrange the robot model 12M, the robot coordinate system C1, the tool coordinate system C2, the workpiece coordinate system C3, and the workpiece model 200M at the virtual space VS as the model arranging unit 52, and generate the image data 110 of the virtual space VS displaying only the tool coordinate system C2 as the image generating unit 54.

In the above-described embodiment, the case has been described in which the processor 32 (image generating unit 54) displays the rotation cursor image 114 (FIGS. 7 and 8) when “rotational movement” is selected in the movement selection button image 112, and rotationally moves the robot model 12M in response to an operation on the rotation cursor image 114. However, the processor 32 may receive an input for designating, for example, the rotation amount for rotating the end effector model 28M and the axis of the control coordinate system C as the rotation center without displaying the rotation cursor image 114.

Furthermore, the movement selection button image 112 may be omitted from the image data 110. In this case, the processor 32 may be configured to switch between translational movement and rotational movement in response to a predetermined command input (e.g., a function key input etc.) to the input device 40 by the operator. Note that the model arranging unit 52 and the image generating unit 54 can be omitted from the device 50. For example, the operator may manually input the coordinates Qw of the work position Pw without visually recognizing the image data 110 as illustrated in FIG. 5. The workpiece model 200M may be a two-dimensional CAD model. Note that the processor 32 may execute the above-described teaching process in accordance with the computer program PG1. The computer program PG1 can be recorded in advance in the memory 34.

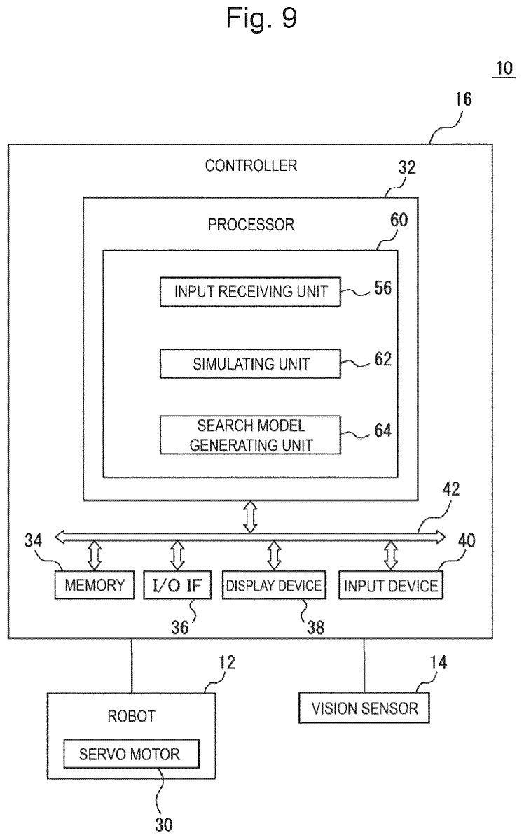

Next, another function of the robot system 10 will be described with reference to FIG. 9. In the present embodiment, the processor 32 executes a search model generation process of generating the search model 200S for searching for the workpiece 200 from the image data 140 obtained by imaging the workpiece 200. Hereinafter, a case of generating a search model 200S used when carrying out a work by executing the above-described operation program OP_{A} will be described.

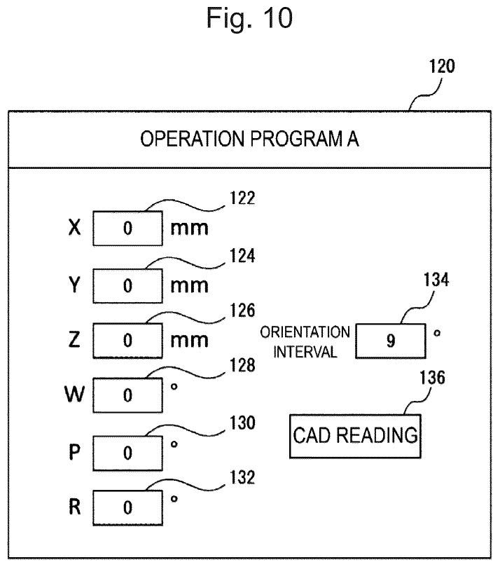

After the start of the search model generation process, the processor 32 generates the search model setting image data 120 illustrated in FIG. 10 and displays the same on the display device 38. The search model setting image data 120 is a GUI for assisting the work of generating the search model 200S by the operator. Specifically, the search model setting image data 120 includes position input images 122, 124, and 126, orientation input images 128, 130, and 132, an orientation interval input image 134, and a model reading button image 136.

The model reading button image 136 is a GUI for selecting a workpiece model of a workpiece to be an actual work target from among various workpiece models recorded in the memory 34. For example, when the operator clicks the model reading button image 136 on the image by operating the input device 40, a list of various workpiece models (e.g., a list of file names, model names, workpiece identification codes, etc.) recorded in the memory 34 is displayed. The operator can select the workpiece model of the workpiece to be the work target from the displayed workpiece models. In the present embodiment, it is assumed that the workpiece model 200M illustrated in FIG. 3 is selected as the workpiece model.

The position input images 122, 124, and 126 are for setting the origin position of the workpiece coordinate system C3. Specifically, the position input images 122, 124, and 126 can input displacement amounts for displacing the origin (e.g., the center of gravity of the workpiece model or the CAD origin) of the workpiece coordinate system C3 serving as an initial setting in the x-axis direction, the y-axis direction, and the z-axis direction of the workpiece coordinate system C3, respectively.

The orientation input images 128, 130, and 132 are for setting the orientation (i.e., the direction of each axis) of the workpiece coordinate system C3. Specifically, the orientation input images 128, 130, and 132 can input angles at which the direction of each axis of the workpiece coordinate system C3 serving as initial settings are rotated about the x-axis, about the y-axis, and about the z-axis of the workpiece coordinate system C3, respectively. The operator can arbitrarily adjust the position and the orientation of the workpiece coordinate system C3 set in the search model 200S by the position input images 122, 124, and 126 and the orientation input images 128, 130, and 132.

The orientation interval input image 134 is a GUI for inputting a change amount θ for changing the orientation of the workpiece model 200M in the virtual space VS in order to generate the search model 200S. The operator can input the change amount θ as an angle θ (in the example of FIG. 10, θ=9°) in the orientation interval input image 134 by operating the input device 40. The processor 32 functions as the input receiving unit 56 and receives an input of the displacement amount θ (angle θ).

After inputting desired values to the position input images 122, 124, and 126, the orientation input images 128, 130, and 132, and the orientation interval input image 134, the operator performs a click operation on the model reading button image 136, and subsequently selects the workpiece model 200M. The processor 32 reads model data (i.e., the CAD data) of the workpiece model 200M in response to an input operation by the operator, and arranges the model data at the virtual space VS together with the workpiece coordinate system C3. At this time, the processor 32 arranges the workpiece coordinate system C3 at the position and orientation set by the position input images 122, 124, and 126 and the orientation input images 128, 130, and 132.

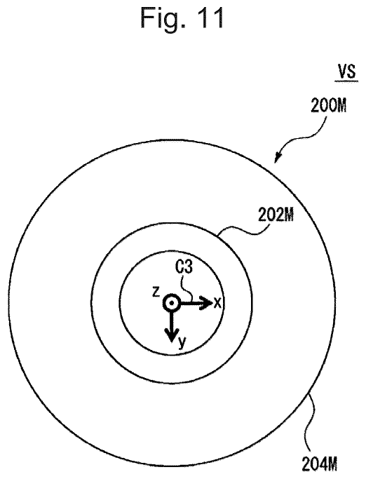

Next, the processor 32 generates a search model 200S₁ at a first orientation when the workpiece model 200M disposed at the virtual space VS is viewed from a predetermined reference viewpoint VP (FIG. 3). FIG. 11 illustrates the workpiece model 200M in the first orientation when viewed from the reference viewpoint VP. The processor 32 generates a search model 200S₁ in the first orientation by giving a point group to a model component (a model such as a surface or an edge) of the workpiece model 200M in the first orientation based on the model date of the workpiece model 200M.

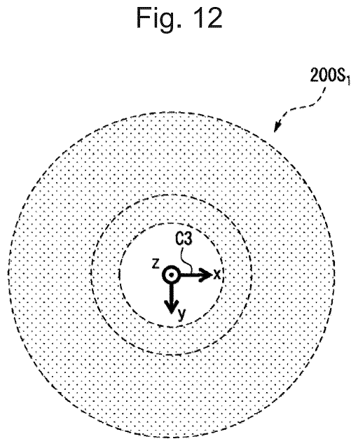

An example of the search model 200S₁ in the first orientation is illustrated in FIG. 12. In the search model 200S₁, a model component (surface model, edge model) of the workpiece model 200M that can be viewed from the reference viewpoint VP in the virtual space VS is represented by a three-dimensional point group. The search model 200S₁ represents the shape of the workpiece model 200M in the first orientation viewed from the reference viewpoint VP by these point groups. Furthermore, the workpiece coordinate system C3 is set for the search model 200S₁. Note that the processor 32 may automatically set the reference viewpoint VP at an arbitrary position in the virtual space VS when the workpiece model 200M is read. Furthermore, the processor 32 may receive an input for determining the reference viewpoint VP from the operator.

Next, the processor 32 performs arithmetic processing of simulatively changing the orientation of the workpiece model 200M in the virtual space VS in accordance with the change amount (angle) θ which input is received through the orientation interval input image 134. Specifically, the processor 32 repeatedly executes the simulative rotation operation VR of rotating the workpiece model 200M by the angle θ input to the orientation interval input image 134 about the x axis (or the y axis) and the z axis of the workpiece coordinate system C3 to change the orientation of the workpiece model 200M in the virtual space VS.

For example, after generating the search model 200S₁ in the first orientation, the processor 32 executes the first simulative rotation operation VRₓ of rotating the workpiece model 200M (FIG. 11) viewed from the reference viewpoint VP by the angle θ (=9°) about the x-axis of the workpiece coordinate system C3. As a result, the orientation of the workpiece model 200M viewed from the reference viewpoint VP changes from the first orientation to the second orientation. As described above, in the present embodiment, it functions as the simulating unit 62 (FIG. 9) configured to simulatively change the orientation of the workpiece model 200M in the virtual space VS in accordance with the change amount (angle) θ which input has been received.

Subsequently, the processor 32 generates the search model 200S₂ of the second orientation representing the shape of the workpiece model 200M in the second orientation viewed from the reference viewpoint VP based on the workpiece model 200M in the second orientation. Thereafter, the processor 32 repeatedly executes the first simulative rotation operation VRₓ of rotating the workpiece model 200M about the x-axis of the workpiece coordinate system C3 by the angle θ, and generates the search model 200Sₙ every time the first simulative rotation operation VRₓ is executed. For example, the processor 32 may rotate the workpiece model 200M about the x axis of the workpiece coordinate system C3 by an angle θ in the range of 0° to π (e.g., π=180° or 360°) with the first orientation illustrated in FIG. 11 as 0°.

In addition to the first simulative rotation operation VRₓ, the processor 32 repeatedly executes a second simulative rotation operation VR_{z} of rotating the workpiece model 200M viewed from the reference viewpoint VP about the z-axis of the workpiece coordinate system C3 by an angle θ. Subsequently, the processor 32 generates the search model 200Sₙ each time the second simulative rotation operation VR_{z} is executed. For example, the processor 32 may rotate the workpiece model 200M about the z axis of the workpiece coordinate system C3 by an angle θ in the range of −π to π (e.g., π=180°) with the first orientation illustrated in FIG. 11 as 0°.

In this way, the processor 32 repeatedly executes the simulative rotation operation VR (VRₓ, VR_{z}) to change the orientation of the workpiece model 200M viewed from the reference viewpoint VP to the first orientation, the second orientation, the third orientation, and the nth orientation, and generates the search model 200S₁ of the first orientation, the search model 200S₂ of the second orientation, the search model 200S3 of the third orientation, . . . , and the search model 200Sₙ of the nth orientation.

As a result, the processor 32 generates a total of n: n=(π/θ+1)·(2π sin φ/θ+1) search models 200Sₙ. Note that φ represents an angle at which the workpiece model 200M is rotated about the z axis of the workpiece coordinate system C3. In this manner, in the present embodiment, the processor 32 functions as a search model generating unit 64 (FIG. 9) configured to generate the search model 200Sₙ based on the workpiece model 200M. The search model 200Sₙ generated in this way is used to search for the workpiece 200 from the image data 140 of the workpiece 200 imaged by the vision sensor 14 for actual work. An actual work flow will be described later.

Note that when generating the search model 200Sₙ, the processor 32 may generate the point group data of the model component on the front side that can be seen from the reference viewpoint VP in the virtual space VS, but need not generate the point group data of the model component on the back side that cannot be seen from the reference viewpoint VP (e.g., the edge model and the surface model on the back side of the plane of drawing among the model components of the workpiece model 200M in FIG. 11). According to this configuration, the data amount of the search model 200Sₙ can be reduced.

As a result of the search model generation process described above, the data of the workpiece model 200M selected by the operation of the model read button image 136 is registered in association with the operation program OP_{A} together with the specifying information Is thereof. The data of the search model 200Sₙ is registered in association with the operation program OP_{A} and the workpiece model 200M (specifying information Is). In this manner, the operation program OP_{A}, the teaching position Pwₜ, the workpiece model 200M, and the search model 200Sₙ are associated with each other.

As described above, in the present embodiment, the processor 32 functions as the input receiving unit 56, the simulating unit 62, and the search model generating unit 64, and generates the search model 200Sₙ. Therefore, the input receiving unit 56, the simulating unit 62, and the search model generating unit 64 constitute a device 60 (FIG. 9) configured to generate the search model 200Sₙ.

In the device 60, the input receiving unit 56 receives an input of the change amount θ for changing the orientation of the workpiece model 200M in the virtual space VS, and the simulating unit 62 simulatively changes the orientation of the workpiece model 200M in the virtual space VS in accordance with the change amount θ received by the input receiving unit 56. When the simulating unit 62 changes the orientation, the search model generating unit 64 generates the search model 200Sₙ representing the shape of the workpiece model 200M viewed from the predetermined viewpoint VP in the virtual space VS based on the workpiece model 200M.

According to this configuration, the operator can automatically generate the search model 200Sₙ in various orientations only by inputting the change amount θ. Thus, the work of preparing the search model 200Sₙ can be greatly simplified. In addition, the operator can arbitrarily design the orientations and the number of search models 200Sₙ to be generated by appropriately selecting the change amount θ. Therefore, degree of freedom of design of the search model 200Sₙ can be increased.

Furthermore, in the device 60, the input receiving unit 56 receives, as the change amount θ, the input of the angle θ for rotating the workpiece model 200M about the axis (x-axis, y-axis, z-axis) of the coordinate system C (workpiece coordinate system C3) set in the virtual space VS, and the simulating unit 62 repeatedly executes the simulative rotation operation VR for rotating the workpiece model 200M about the axis by the angle θ to change the orientation of the workpiece model 200M.

Subsequently, the search model generating unit 64 generates the search model 200Sₙ every time the simulating unit 62 executes the simulative rotation operation VR. According to this configuration, the operator can change the orientation of the workpiece model 200M with reference to the axis of the coordinate system C set in the virtual space VS. Therefore, the orientation of the search model 200Sₙ to be generated can be effectively designed.

Furthermore, in the device 60, the simulating unit 62 executes the first simulative rotation operation VRₓ of rotating the workpiece model 200M about the first axis (e.g., the x-axis of the workpiece coordinate system C3) and the second simulative rotation operation VR_{z} of rotating the workpiece model 200M about the second axis (e.g., the z-axis of the workpiece coordinate system C3) orthogonal to the first axis. According to this configuration, the orientation of the search model 200Sₙ to be generated can be designed more variously and easily.

Note that in the above-described embodiment, the case where the processor 32 (input receiving unit 56) receives the input of the angle θ for rotating the workpiece model 200M about the axis of the workpiece coordinate system C2 as the displacement amount θ has been described. However, this is not the sole case, and the displacement amount θ may be determined in advance as a required value (e.g., θ=9°).

In addition, the search model setting image data 120 illustrated in FIG. 10 is an example, and any other GUI may be adopted. For example, the displacement amount θ has an angle θx by which the workpiece model 200M is rotated about the x axis (or y axis) of the workpiece coordinate system C3 and an angle θz by which the workpiece model is rotated about the z axis of the workpiece coordinate system C3, and the search model setting image data 120 may have an orientation interval input image 134x for inputting the angle θx and an orientation interval input image 134z for inputting the angle θz. Note that the processor 32 may execute the above-described search model generation process in accordance with the computer program PG2. The computer program PG2 can be recorded in advance in the memory 34.

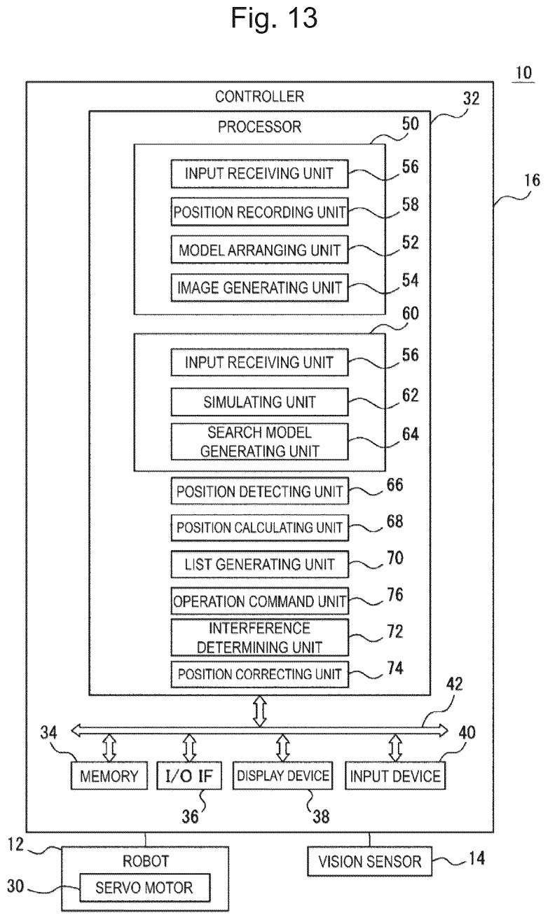

Next, yet another function of the robot system 10 will be described with reference to FIG. 13. The processor 32 functions as the above-described device 50 (i.e., the model arranging unit 52, the image generating unit 54, the input receiving unit 56, and the position recording unit 58), executes the above-described teaching process, and teaches the work position Pw (i.e., the teaching position Pwₜ) to the workpiece model 200M.

Here, in the present embodiment, it is assumed that a total of three working positions Pw₁, Pw₂, and Pw₃ are taught to one workpiece model 200M in the teaching process. That is, in this case, the processor 32 functions as the input receiving unit 56 and receives the input F for teaching the total of three work positions Pw₁, Pw₂, and Pw₃ for one workpiece model 200M. Subsequently, the processor 32 functions as the position recording unit 58 and records the first teaching position Pwₜ₁ (coordinates Qw₁), the second teaching position Pwₜ₂ (coordinates Qw₂), and the third teaching position Pwₜ₃ (coordinates Qw₃) in advance in the memory 34 in association with the workpiece model 200M.

Furthermore, in this teaching process, it is assumed that the operator gives a priority order of “high priority” to the first teaching position Pwₜ₁, a priority order of “medium priority” to the second teaching position Pwₜ₂, and a priority order of “low priority” to the third teaching position PWₜ₃ with respect to the recorded three teaching positions Pwₜₘ (m=1, 2, 3). That is, in this case, the processor 32 functions as the input receiving unit 56 and receives the input G for determining the priority order (“high priority”, “medium priority”, and “ ow priority”) of the three work positions Pwₜₘ.

In addition, the processor 32 functions as the above-described device 60 (i.e., the input receiving unit 56, the simulating unit 62, and the search model generating unit 64), executes the above-described search model generation process, and generates the search model 200Sₙ of various orientations based on the workpiece model 200M. The generated search model 200Sₙ is recorded in the memory 34 in advance.

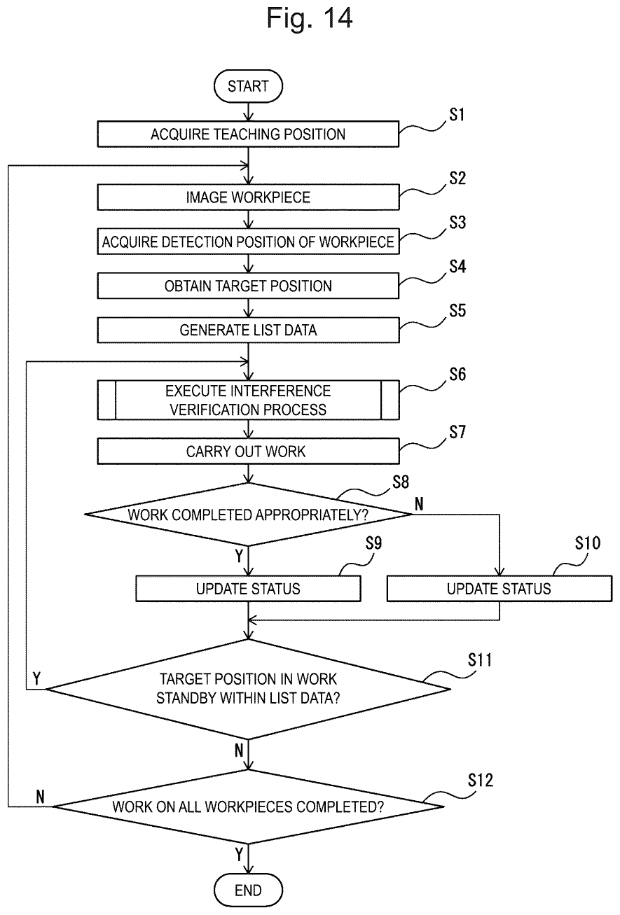

After executing the teaching process and the search model generation process, the processor 32 executes the flow illustrated in FIG. 14. The flow of FIG. 14 is for carrying out a work (workpiece handling) on the workpiece 200 in the container B. The operator operates the input device 40 to designate the operation program OP_{A} in which various parameters are set by the teaching process and the search model generation process described above as the operation program OP for executing the flow of FIG. 14.

When receiving a work start command from the operator or the host controller, the processor 32 executes the operation program OPA, thereby starting the flow of FIG. 14. In step S1, the processor 32 acquires the teaching position Pwₜₘ (m=1, 2, 3) taught to the workpiece model 200M. Specifically, the processor 32 reads and acquires the data of the teaching position Pwₜₘ registered in association with the operation program OP_{A} being executed and the workpiece model 200M from the memory 34.

In step S2, the processor 32 images the workpiece 200 in the container B by the vision sensor 14. Specifically, the processor 32 operates the vision sensor 14 to image the image data 140 of the workpiece 200. The processor 32 acquires the imaged image data 140 from the vision sensor 14. An example of the image data 140 is illustrated in FIG. 15.

As illustrated in FIG. 15, in the present embodiment, the image data 140 is three-dimensional point cloud image data, and the visual characteristic (i.e., a surface, an edge, etc.) of the imaged workpiece 200 is represented by a point group. Each point constituting the point group has information on the distance d described above. Note that FIG. 15 illustrates an example in which a total of three workpieces 200 appear in the image data 140, but it should be understood that three or more workpieces may actually appear.

In step S3, the processor 32 searches for the workpiece 200 appearing in the image data 140 acquired in the most recent step S2 using the search model 200Sₙ generated in advance, thereby acquiring the detection position Pd of the workpiece 200 appearing in the image data 140. Specifically, the processor 32 sequentially matches the search models 200Sₙ in various orientations with a point group representing the workpiece 200 appearing in the image data 140, and calculates a score SC as a result of the matching every time the matching is executed.

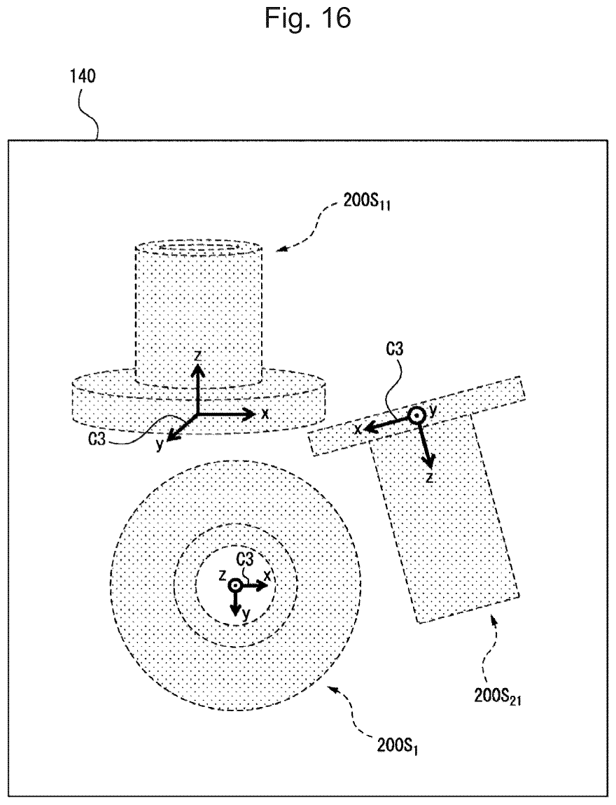

The score SC represents the degree of similarity (or the degree of difference) between the point group representing the workpiece 200 and the search model 200Sₙ, and the higher (or the lower) the score SC is, the more similar the two are. When the calculated score SC is greater than a predetermined threshold value, the processor 32 determines that the point group of the workpiece 200 and the search model Sₙ are highly matched. FIG. 16 illustrates a state in which the search models 200S₁, 200S₁₁, and 200S₂₁ are highly matched with respect to the point group of the workpiece 200.

As described above, the workpiece coordinate system C3 is set for each of the search models 200S₁, 200S₁₁, and 200S₂₁ matching the point group of the workpiece 200. The processor 32 acquires coordinates Qd₁, Qd₁₁, and Qd₂₁ in the robot coordinate system C1 of the workpiece coordinate system C3 set to the matched search models 200S₁, 200S₁₁, and 200S₂₁, respectively.

Here, the position of the vision sensor 14 in the robot coordinate system C1 is known by calibration. Therefore, the coordinates in the robot coordinate system C1 of the point group appearing in the image data 140 imaged by the vision sensor 14 are also known. Therefore, the processor 32 can acquire coordinates Qd₁, Qd₁₁, and Qd₂₁ in the robot coordinate system C1 of each workpiece coordinate system C3 when the search models 200S₁, 200S₁₁, and 200S₂₁ are matched with the point group, as illustrated in FIG. 16.

In this way, the processor 32 searches for the workpiece 200 appearing in the image data 140 using the search model 200Sₙ. The processor 32 records the coordinates Qd₁, Qd₁₁, and Qd₂₁ acquired as a result of the search in the memory 34 as detection positions Pd₁, Pd₁₁, and Pd₂₁ indicating the position of the workpiece 200 at the time of imaging of the image data 140.

As described above, in the present embodiment, the processor 32 functions as the position detecting unit 66 (FIG. 13) configured to acquire the position of the workpiece 200 as the detection position Pd₁, Pd₁₁, and Pd₂₁ (specifically, the coordinates Qd₁, Qd₁₁, and Qd₂₁) by searching for the workpiece 200 appearing in the image data 140 using the search model 200Sₙ.

In step S4, the processor 32 obtains the target position Pt of the work on the workpiece 200 in which the detection position Pd_{q} is detected based on the teaching position Pwₜₘ acquired in step S1 and the detection position Pd_{q} (q=1, 11, 21) acquired in the immediately preceding step S3. Specifically, the processor 32 performs a predetermined calculation (specifically, multiplication of coordinates and a transformation matrix) using a coordinate Qd₁ in the robot coordinate system C1 representing the detection position Pd₁, a coordinate Qw₁ in the workpiece coordinate system C3 representing the first teaching position Pwₜ₁, and a transformation matrix MX (e.g., a homogeneous transformation matrix or a Jacobian matrix) between the robot coordinate system C1 and the workpiece coordinate system C3 to obtain a coordinate Qr_{1_1} representing the coordinate Qw₁ in the robot coordinate system C1.

The coordinate Qr_{1_1} represents the coordinate in the robot coordinate system C1 of the first teaching position Pwₜ₁ taught to the workpiece 200 (i.e., the workpiece 200 with which the search model 200S₁ in FIG. 16 is matched), which detection position Pd₁ has been detected. The processor 32 obtains the coordinate Qr_{1_1} as the first target position Pt_{1_1} representing the first work position Pw₁ on the workpiece W of the detection position Pd₁.

Similarly, for the detection position Pd₁, the processor 32 obtains the second target position Pt_{1_2} (coordinate_{1_2} of the robot coordinate system C1) corresponding to the second teaching position Pwₜ₂, and obtains the third target position Pt_{1_3} (coordinate Qr_{1_3} of the robot coordinate system C1) corresponding to the third teaching position Pwₜ₃. In this way, the processor 32 obtains three target positions Pt_{1_1}, Pt_{1_2}, and Pt_{1_3} for the detection position Pd₁ of one workpiece 200 detected in step S3.

Similarly, for the detection position Pd₁₁ (i.e., the workpiece 200 matched with the search model 200S₁₁ in FIG. 16), the processor 32 obtains a first target position Pt_{11_1} (coordinate Qr_{2_1} in the robot coordinate system C1) corresponding to the first teaching position Pwₜ₁, a second target position Pt_{11_2} (coordinate Qr_{11_2} in the robot coordinate system C1) corresponding to the second teaching position Pwₜ₂, and a third target position Pt_{11_3} (coordinate Qr_{11_3} in the robot coordinate system C1) corresponding to the third teaching position Pwₜ₃.

Furthermore, for the detection position Pd₂₁ (i.e., the workpiece 200 matched with the search model 200S₂₁ in FIG. 16), the processor 32 obtains the first target position Pt_{21_1} (coordinates Qr_{21_1} in the robot coordinate system C1) corresponding to the first teaching position Pwₜ₁, the second target position Pt_{21_2} (coordinate Qr_{21_2} in the robot coordinate system C1) corresponding to the second teaching position Pwₜ₂, and the third target position Pt_{21_3} (coordinate Qr_{21_3} in the robot coordinate system C1) corresponding to the third teaching position Pwₜ₃.

In this way, when three detection positions Pd_{q} (q=1, 11, 21) are acquired in step S3, the processor 32 obtains a total of nine target positions Pt_{q_m} (q=1, 11, 21 m=1, 2, 3) by calculation. The processor 32 records the obtained target position Pt_{q_m} in the memory 34. As described above, in the present embodiment, the processor 32 functions as a position calculating unit 68 (FIG. 13) configured to obtain the target position Pt_{q_m} (coordinate Qr_{q_m}) by calculation based on the teaching position Pwₜₘ acquired in step S1 and the detection position Pd_{q} (coordinate Qd_{q}) acquired in step S3.

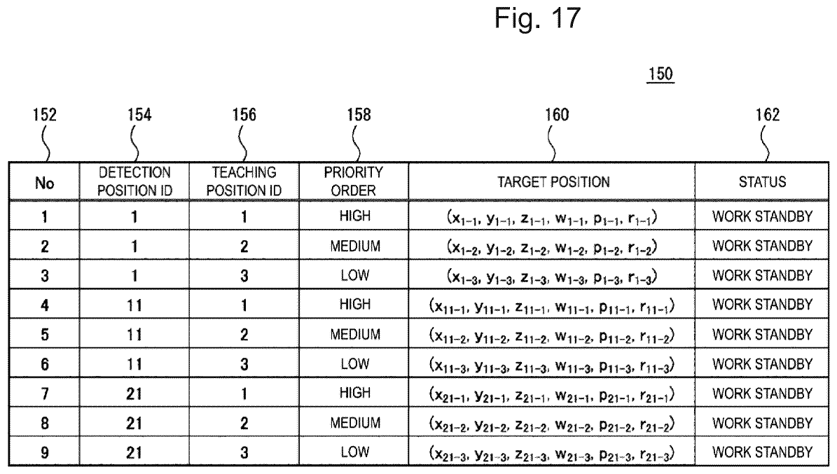

In step S5, the processor 32 generates the list data 150 in which the plurality of target positions Pt_{q_m} obtained in the immediately preceding step S4 are lined up in the form of a list. An example of the list data 150 is illustrated in FIG. 17. In the list data 150 illustrated in FIG. 17, a column 152 indicated by “No” represents the order of the target position Pt_{q_m}. Furthermore, t column 154 indicated as “detection position ID” represents the identification ID: “q” of the detection position Pd_{q} (q=1, 11, 21) obtained in step S3.

In addition, a column 156 indicated as “teaching position ID” represents the identification ID: “m” of the teaching position Pwₜₘ (m=1, 2, 3) taught in advance. In addition, a column 158 indicated as “priority order” represents a priority order given in advance to each of the teaching positions Pwₜₘ. Furthermore, a column 160 indicated as “target position” indicates the target position Pt_{q_m} (i.e., the coordinate Qr_{q_m}) obtained in step S4. In addition, a column 152 indicated as “status” represents a state of the work. “Work standby” in the column 162 represents a state in which work on the workpiece 200 has not been completed and the work is scheduled to be executed.

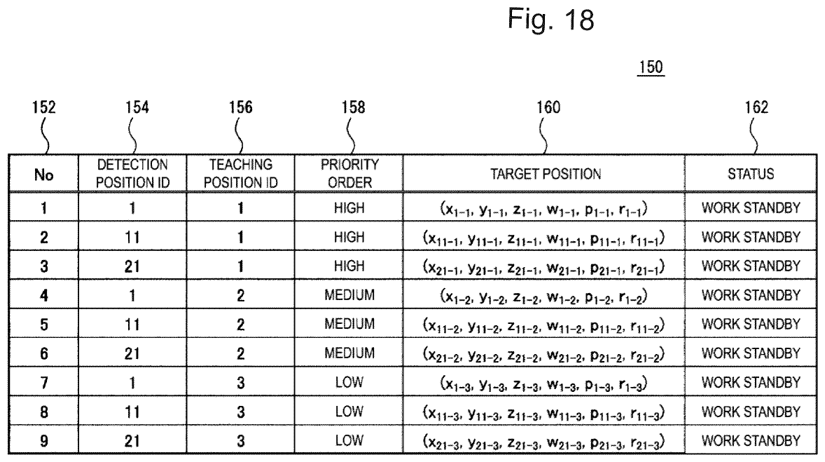

Here, the processor 32 rearranges the target position Pt_{q_m} included in the list data 150 of FIG. 17 in accordance with the “priority order”. As a result, the processor 32 updates the list data 150 as illustrated in FIG. 18. In the updated list data 150, the plurality of target positions Pt_{q_m} are rearranged in the order of high priority, medium priority, and low priority.

The list data 150 illustrated in FIG. 18 includes three target positions Pt_{1_1} (coordinate Qr_{1_1}), Pt_{11_1}(coordinate Qr_{11_1}), and Pt_{21_1}(coordinate Qr_{21_1}) as the high priority target position Pt_{q_m}. Similarly, three target positions Pt_{q_m} are included for each of the medium priority and the low priority. Therefore, the processor 32 further rearranges the target positions Pt_{q_m} having the same priority in accordance with the magnitude of the z coordinate of the robot coordinate system C1 (i.e., the height in the vertical direction) in order to further determine the priority orders of the order of work for the three target positions Pt_{q_m} to which the same priority is given.

It is assumed that the relationship z_{21_1}>z_{1_1}>z_{11_1}holds among the z coordinate z_{1_1} of the high priority target position Pt_{1_1}, the z coordinate z_{11_1} of the target position Pt_{11_1}, and the z coordinate z_{21_1} of the target position Pt_{21_1}. Furthermore, it is assumed that the relationship z_{21_2}>z_{1_2}>z_{11_2} holds for the z coordinates of the medium priority target positions Pt_{1_2}, t_{11_2}, and t_{21_2}. Moreover, it is assumed that the relationship z_{21_3}>z_{1_3}>z_{11_3} holds for the z coordinates of the low priority target positions Pt_{1_3}, t_{11_3}, and t_{21_3}.

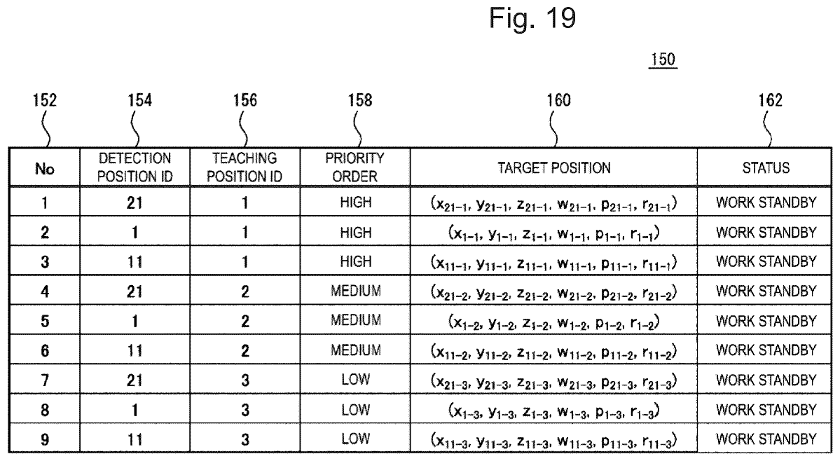

In this case, the processor 32 rearranges the target positions Pt_{q_m} having the same priority in accordance with the z coordinate, and further updates the list data 150 as illustrated in FIG. 19. In this way, the processor 32 generates the list data 150 in which the plurality of target positions Pt_{q_m} are arranged. Therefore, the processor 32 functions as the list generating unit 70 (FIG. 13) configured to generate the list data 150.

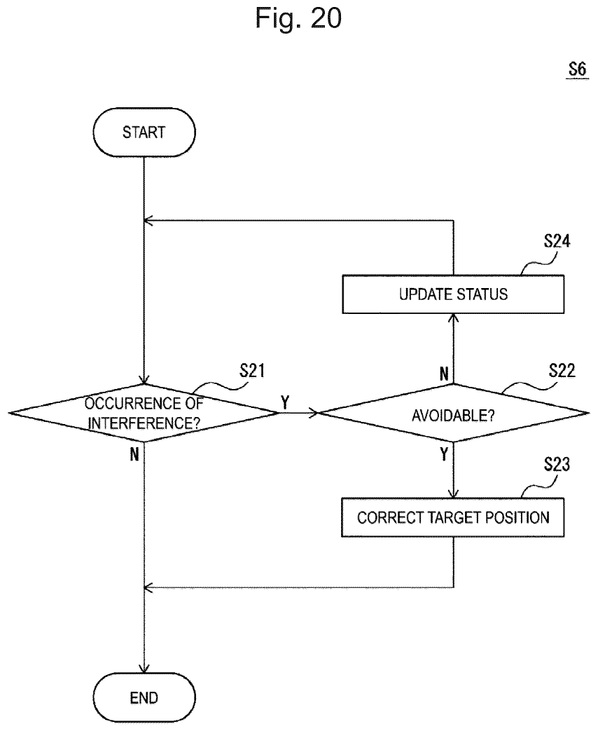

Referring again to FIG. 14, in step S6, the processor 32 executes an interference verification process. This step S6 is described with reference to FIG. 20. In step S21, the processor 32 determines whether or not interference occurs between the robot 12 and the environmental object E (not illustrated) when the robot 12 is positioned at the target position Pt_{q_m}.

Specifically, the processor 32 determines whether or not interference occurs with respect to the target position Pt_{q_m} whose order indicated in the column 152 is the highest (i.e., the priority order in the column 158 is the highest) among the target positions Pt_{q_m} whose “status” is “work standby” in the list data 150 of FIG. 19 at this time point. If step S21 is executed for the first time, the processor 32 performs the interference determination for the “high priority” target position Pt_{21_1}: coordinates Qr_{21_1} (x_{21_1}, y_{21_1}, z_{21_1}, w_{21_1}, p_{21_1}, r_{21_1}) at the top (order No. 1) of the list data 150 in FIG. 19.

More specifically, the processor 32 calculates whether or not the end effector model 28M interferes with the model of the environmental object E (e.g., the container B or the other workpiece 200) when the end effector model 28M of the robot model 12M is positioned at the coordinate Qr_{21_1} of the robot coordinate system C1 based on the image data 140 acquired in step S2, the coordinate Qr_{21_1}, and the robot model 12M.

When the interference occurs, the processor 32 determines as YES and proceeds to step S22, and when determining as NO, the processor proceeds to step S7 in FIG. 14. Thus, in the present embodiment, the processor 32 functions as an interference determining unit 72 (FIG. 13) configured to determine whether or not interference occurs between the robot 12 and the environmental object E when the robot 12 is positioned at the target position Pt_{q_m}.

In step S22, the processor 32 determines whether or not the interference between the robot 12 and the environmental object E can be avoided. Specifically, the processor 32 calculates a corrected position Pt_{q_m}′ obtained by displacing the target position Pt_{q_m} (e.g., the target position Pt_{21_1}) subjected to interference determination in the most recent step S21 to a position at which interference can be avoided and work can be executed in the robot coordinate system C1 in accordance with the predetermined interference avoidance condition CD.

The interference avoidance condition CD includes, for example, an allowable range of a displacement amount (specifically, a change amount of the position and the orientation) from the target position Pt_{q_m}. In step S22, the processor 32 determines YES when the corrected position Pt_{q_m}′ has been calculated, and proceeds to step S23, and on the other hand, proceeds to step S24 when determination is made as NO. In step S23, the processor 32 corrects the target position Pt_{q_m} subjected to interference determination in the most recent step S21 to the corrected position Pt_{q_m}′ calculated in the immediately preceding step S22. Subsequently, the processor 32 proceeds to step S7 in FIG. 14. As described above, in the present embodiment, the processor 32 functions as the position correcting unit 74 (FIG. 13) configured to correct the target position Pt_{q_m}.

In step S24, the processor 32 updates the status. Specifically, the processor 32 functions as the list generating unit 70, and changes the “status” of the target position Pt_{q_m} (e.g., the target position Pt_{21_1}) subjected to the interference determination in the most recent step S21 to “interference avoidance calculation failure” representing that the interference avoidance calculation has failed in step S22 in the list data 150 illustrated in FIG. 19. Note that the processor 32 may delete the target position Pt_{q_m} set as “interference avoidance calculation failure” from the list data 150.

Subsequently, the processor 32 returns to Step S21 and sequentially executes the flow of steps S21 to S24 for the target position Pt_{q_m} (e.g., the target position Pt_{1_1} of order No. 2) in which the order of the column 152 in the list data 150 illustrated in FIG. 19 is the second place and the status is “work standby”. In this way, the processor 32 sequentially performs the interference determination on the target position Pt_{q_m} in accordance with the order indicated in the column 152 of the list data 150 of FIG. 19 (in other words, the priority order of the column 158).

Referring again to FIG. 14, in step S7, the processor 32 executes work on the workpiece 200. For example, it is assumed that the processor 32 has determined as NO for the highest-order target position Pt_{21_1} in the list data 150 of FIG. 19 in the immediately preceding step S21. In this case, in step S7, the processor 32 generates a command for each servo motor 30 of the robot 12 based on the target position Pt_{21_1} (coordinate Qr_{21_1}) and controls the robot 12 in accordance with the command, thereby positioning the end effector 28 at the coordinate Qr_{21_1} in the robot coordinate system C1.

Subsequently, the processor 32 operates the end effector 28 to grip the workpiece 200 matched with the search model 200S₂₁ in FIG. 16 at the first work position Pw₁. In this way, the robot 12 executes work (workpiece handling) on the workpiece 200. As described above, in the present embodiment, the processor 32 functions as an operation command unit 76 (FIG. 13) configured to control the robot 12 based on the target position Pt_{21_1} having the highest priority order in the list data 150 and position the robot 12 at the highest target position Pt_{21_1}.

On the other hand, it is assumed that the processor 32 corrects the target position Pt_{q_m} to the corrected position Pt_{q_m}′ in the immediately preceding step S23. In this case, in step S7, the processor 32 controls the robot 12 based on the corrected position Pt_{q_m}′, and positions the end effector 28 at the corrected position Pt_{q_m}′ in the robot coordinate system C1. Subsequently, the processor 32 operates the end effector 28 to grip the workpiece 200 at the work position Pw₁′ corresponding to the corrected position Pt_{q_m}′.

In step S8, the processor 32 determines whether or not the work executed in the immediately preceding step S7 has been appropriately completed. The processor 32 proceeds to step S9 when determining as YES, and proceeds to step S10 upon determining NO. In step S9, the processor 32 functions as the list generating unit 70, and changes the “status” of the target position Pt_{q_m} used in the work of the most recent step S7 to “work successful” representing that the work is appropriately completed in the list data 150 of FIG. 19.

For example, when the work of step S7 is completed using the highest-order target position Pt_{21_1} in the list data 150 of FIG. 19, the processor 32 changes the “status” of the highest target position Pt_{21_1} to “work successful” in the list data 150. At this time, in the column 154 of the list data 150, the processor 32 also changes the “status” of the target position Pt_{21_2} of order No. 4 and the target position Pt_{21_3} of order No. 7 to which the same identification ID: m=21 as the target position Pt_{21_1} is given to “work successful”. Note that the processor 32 may delete the target position Pt_{q_m} (e.g., the target positions Pt_{21_1}, Pt_{21_2}, and Pt_{21_3}) determined as “work successful” from the list data 150.

In step S10, the processor 32 functions as the list generating unit 70 and changes the “status” of the target position Pt_{q_m} used in the work of the most recent step S7 to “work failure” representing that the work has not been appropriately completed in the list data 150 of FIG. 19. For example, it is assumed that the processor 32 determines NO in step S8 as a result of executing the work using the target position Pt_{21_1} of order No. 1 in the most recent step S7. In this case, in step S10, the processor 32 changes the “status” of the target position Pt_{21_1} of order No. 1 to “work failure”.

At this time, the processor 32 may also change the “status” of the target position Pt_{21_2} of order No. 4 and the target position Pt_{21_3} of order No. 7 to which the same identification ID: m=21 as the target position Pt_{21_1} is given to “work failure”. The processor 32 may delete the target position Pt_{q_m} set as “work failure” from the list data 150.

In step S11, the processor 32 determines whether or not there is a target position Pt_{q_m} for which the “status” of the column 152 is “work standby” in the list data 150 at this time point. In a case of determining as YES, the processor 32 returns to step S6, and sequentially executes steps S6 to S10 for the target position Pt_{q_m} having the highest order indicated in the column 152 (i.e., the highest priority order in the column 158) among the target positions Pt_{q_m} in “work standby”. On the other hand, when determined as NO, the processor 32 proceeds to step S12.

In step S12, the processor 32 determines whether or not the work on all the workpieces 200 in the container B has been completed. The processor 32 ends the flow shown in FIG. 14 if the determination is made as YES and returns to step S2 if the determination is made as NO. Subsequently, in step S2 again, the processor 32 causes the vision sensor 14 to image the workpiece 200 in the container B, and executes the flow of steps S2 to S12 based on the newly imaged image data 140.

As described above, in the present embodiment, the controller 16 has the functions of the devices 50 and 60, the position detecting unit 66, the position calculating unit 68, the list generating unit 70, the interference determining unit 72, the position correcting unit 74, and the operation command unit 76. The position detecting unit 66 searches for the workpiece 200 appearing in the image data 140 imaged by the vision sensor 14 using the search model 200Sₙ generated by the search model generating unit 64, thereby acquiring the position of the workpiece 200 appearing in the image data 140 as the detection position Pd_{q} (coordinate Qd_{q}) (step 3).

The position calculating unit 68 calculates the work position Pwₘ on the workpiece 200 in which the detection position Pd_{q} is detected as the target position Pt_{q_m} based on the teaching position Pwₜₘ recorded by the position recording unit 58 and the detection position Pd_{q} acquired by the position detecting unit 66 (step S4). According to this configuration, the workpiece 200 can be effectively searched for from the image data 140 using the search models 200Sₙ in various orientations having the above-described advantages. In addition, the teaching position Pwₜₘ taught to the workpiece model 200M can be shared and used among the search models 200Sₙ in various orientations, and the target position Pt_{q_m} of the work on the workpiece 200 detected by the search model 200Sₙ can be effectively calculated.

In the present embodiment, the list generating unit 70 generates the list data 150 in which the plurality of target positions Pt_{q_m} obtained by the position calculating unit 68 are lined up in the form of a list (step S5). According to this configuration, it is possible to effectively manage the plurality of target positions Pt_{q_m} in the list data 150, and thereby effectively manage the order of operations on the workpiece 200. As a result, the work can be smoothly carried out.

In addition, in the present embodiment, the input receiving unit 56 further receives the input G for determining the priority order of the taught work position Pwₘ, and the list generating unit 70 generates the list data 150 (FIGS. 18 and 19) in which the plurality of target positions Pt_{q_m} are arranged in accordance with the priority order received by the input receiving unit 56. Subsequently, the operation command unit 76 controls the robot 12 based on the target position Pt_{q_m} having the highest priority order (e.g., the target position Pt_{21_1}) in the list data 150, and positions the robot 12 at the highest-order target position Pt_{q_m} in order to carry out the work (step S7). According to this configuration, the operator can arbitrarily determine the priority order so as to prioritize the target position Pt_{q_m} at which the robot 12 can easily carry out a work. As a result, it is possible to reduce the possibility of the work failing, thereby improving the work efficiency.

Furthermore, in the present embodiment, the interference determining unit 72 determines whether or not interference occurs between the robot 12 and the environmental object E when the robot 12 is positioned at the target position Pt_{q_m} (step S21). Here, the interference determining unit 72 sequentially performs interference determination on the plurality of target positions Pt_{q_m} included in the list data 150 in accordance with the priority order.

Subsequently, the operation command unit 76 controls the robot 12 based on the highest-order target position Pt_{q_m} (for example, the target position Pt_{21_1}) determined by the interference determining unit 72 as not causing interference (i.e., NO in step S21) among the plurality of target positions Pt_{q_m} included in the list data 150. According to this configuration, the interference determination is performed in the priority order determined by the operator, and the work can be executed using the higher order target position Pt_{q_m} in which the interference does not occur. Accordingly, work efficiency can be further effectively improved.

Note that in step S10 described above, the processor 32 may function as the list generating unit 70 to also change the “status” of the target position Pt in the vicinity of the target position Pt_{q_m} whose “status” has been changed to “work failure” to “work failure” (or “work suspended”). For example, it is assumed that the processor 32 determines NO in step S8 as a result of executing the work using the target position Pt_{21_1} of the order No. 1 in the list data 150 in FIG. 19 in the most recent step S7.

In this case, as described above, the processor 32 changes the “status” of the target position Pt_{21_1} of the order No. 1, the target position Pt_{21_2} of the order No. 4, and the target position Pt_{21_3} of the order No. 7 to “work failure”. At this time, the processor 32 also changes the “status” of the target position Pt_{q_m} obtained for the workpiece 200 within the range of the predetermined distance Δ from the workpiece 200 from which the target position Pt_{21_1} of order No. 1 is acquired (i.e., the workpiece 200 with which the search model 200S₂₁ in FIG. 16 is matched) to “work failure” (or “work suspended”).

For example, in FIG. 16, it is assumed that a workpiece 200 matched with the search model 200S₁₁ is present within a range of a predetermined distance A from the workpiece 200 matched with the search model 200S₂₁. In this case, the processor 32 also changes the “status” of the target position Pt_{11_1} of order No. 3, the target position Pt_{11_2} of order No. 6, and the target position Pt_{11_3} of order No. 9 obtained for the workpiece 200 to “work failure” (or “work suspended”) in the list data 150 of FIG. 19.

Here, when the work on one workpiece 200 fails, the position of another workpiece 200 in the vicinity thereof may change. When such a change in the position of the other workpiece 200 occurs, there is a high possibility that the work will fail even if the work is executed by positioning the end effector 28 at the target position Pt_{q_m} obtained for the other workpiece 200. Therefore, by changing the “status” of the target position Pt in the vicinity of the target position Pt_{q_m} at which the work has failed to “work failure”, the possibility of frequent occurrence of work failure can be reduced and thus the work efficiency can be enhanced.

Note that in the flow illustrated in FIG. 14, the case where the processor 32 executes step S1 after the start of the flow has been described. However, the present invention is not limited thereto, and for example, the processor 32 may execute step S1 after step S3, or may execute step SI at any timing before execution of step S4. Furthermore, steps S8 through S11 may be omitted from the flow of FIG. 14.

Note that, in the above-described embodiment, the case where the processor 32 (device 60) generates the search model 200Sₙ in advance before executing the flow of FIG. 14 has been described. However, the present invention is not limited thereto, and the processor 32 may generate the search model 200Sₙ during the execution of the flow of FIG. 14. For example, before the flow of FIG. 14, the operator inputs parameters such as the origin position and the change amount (angle) θ of the workpiece coordinate system C3 through the search model setting image data 120 illustrated in FIG. 10, and selects the workpiece model 200M through the model reading button image 136. Subsequently, the processor 32 may generate the search model 200Sₙ after the start of the flow of FIG. 14, for example, immediately after step S1 or S2.

Note that the list generating unit 70 may be omitted from the controller 16 illustrated in FIG. 13. In this case, step S5 is omitted from the flow of FIG. 14. In this case, the processor 32 may search for one workpiece 200 in step S3, and obtain one target position Pt_{q_m} in step S4. Alternatively, when the plurality of detection positions Pd_{q} are acquired in step S3, the processor 32 may obtain one target position Pt_{q_m} for the detection position Pd_{q} having the largest z coordinate in the robot coordinate system C1 among the plurality of acquired detection positions Pd_{q} in step S4.

In the above-described embodiment, the case where the processor 32 (the input receiving unit 56) receives the input G for determining the priority order of the taught work position Pwₜₘ has been described. However, the present invention is not limited thereto, and priority order need not be given to the work position Pwₜₘ. In this case, the processor 32 may execute steps S6 and S7 in FIG. 14 in accordance with the order shown in the column 152 of the list data 150 in FIG. 17.

Alternatively, in step S5, the processor 32 may rearrange the target positions Pt_{q_m} included in the list data 150 in FIG. 17 in accordance with the magnitude of the z coordinate in the robot coordinate system C1, or may rearrange the target positions in accordance with any other criterion such as the distance from the wall surface of the container B. Note that the interference determining unit 72 may be deleted from the controller 16 of FIG. 13. In this case, step S6 is omitted from the flow of FIG. 14.

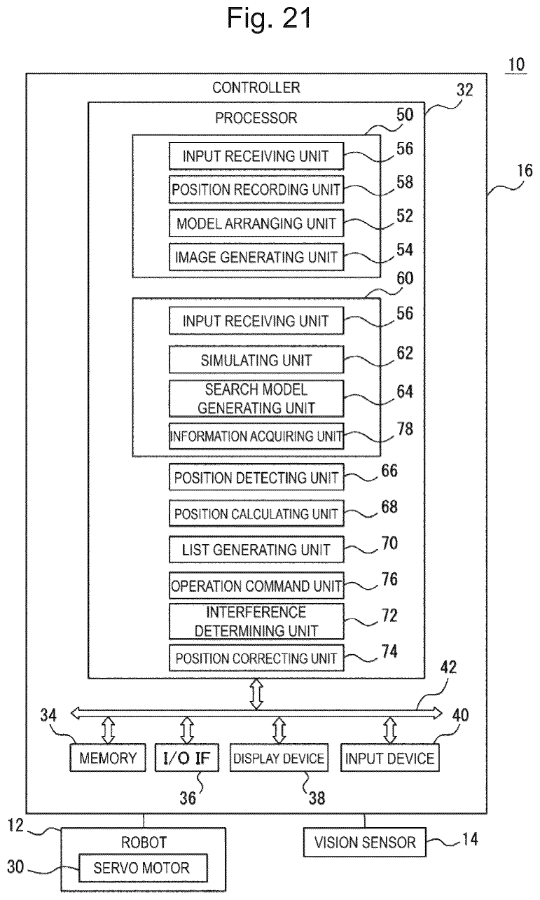

Next, yet another function of the robot system 10 will be described with reference to FIG. 21. In the present embodiment, the device 60 further includes an information acquiring unit 78 configured to acquire symmetry information Im regarding the symmetry of the workpiece model 200M. Specifically, in the search model generation process described above, the processor 32 reads the workpiece model 200M selected in response to the input operation to the model reading button image 136 illustrated in FIG. 10, and arranges the workpiece model at the virtual space VS.

At this time, the processor 32 functions as the information acquiring unit 78, and analyzes the model data (i.e., the CAD data) of the workpiece model 200M and acquires the symmetry information Im. Here, the workpiece may have a predetermined symmetry in its overall shape. For example, in the case of the workpiece 200 illustrated in FIG. 3, the overall shape thereof has rotational symmetry with respect to the central axis A3. In addition, not limited to the cylindrical workpiece 200, for example, when a workpiece having an overall shape (regular quadrangular prism, regular triangular pyramid, etc.) of a regular i-polygon (i=3, 4, 5, . . . ), the workpiece has i-fold symmetry with respect to the central axis.

In the present embodiment, the processor 32 functions as the information acquiring unit 78, and analyzes the model data of the workpiece model 200M, and automatically acquires, as the symmetry information Im, the position data β indicating the position and the direction in the workpiece coordinate system C3 of the central axis A3 (or symmetry axis) of the workpiece model 200M, and the i-fold symmetry information γ. For example, the processor 32 acquires the angle α (=360°/i) as the symmetry information γ.

For example, α=0° (or ∞) is satisfied in the case of the workpiece 200 illustrated in FIG. 3, whereas α=90° is satisfied in the case of a regular quadrangular prism workpiece. The processor 32 records the acquired symmetry information Im (position datum β, information γ: angle α) together with data (coordinates Qw) of the taught teaching position Pwₜ in association with the workpiece model 200M in the memory 34.

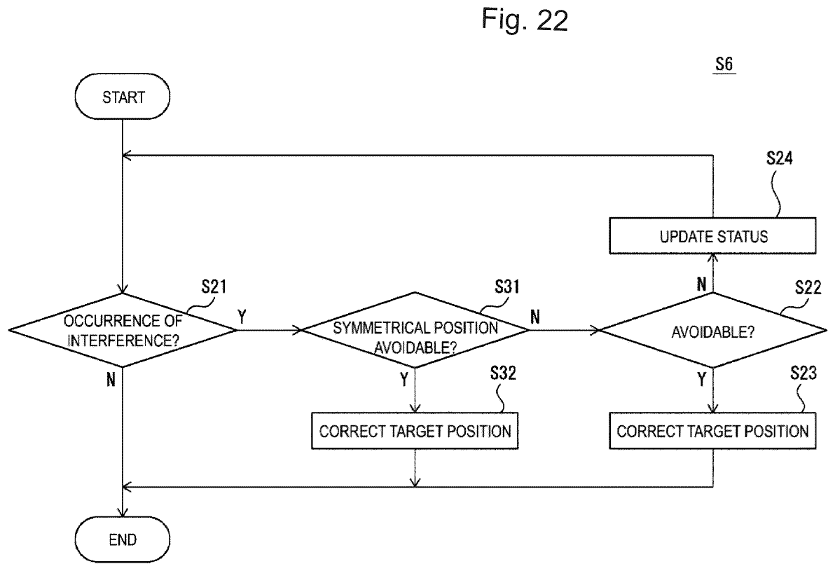

Next, an operation flow executed by the controller 16 illustrated in FIG. 21 will be described with reference to FIGS. 14 and 22. In the present embodiment, the processor 32 executes the flow illustrated in FIG. 22 as step S6 in FIG. 14. In the flow of FIG. 22, when determined as YES in step S21, in step S31, the processor 32 determines whether or not the symmetrical position Pt_{q_m}t″ symmetrical to the target position Pt_{q_m} for which the interference is determined in the immediately preceding step S21 can avoid the interference between the robot 12 and the environmental object E.

Specifically, the processor 32 obtains symmetry information Im (position data β, angle α) of the workpiece model 200M. Subsequently, the processor 32 calculates a symmetrical position Pt_{q_m}″ that is symmetric to the target position Pt_{q_m} based on the position data β and the angle α included in the symmetry information Im and the target position Pt_{q_m} for which interference has been determined.

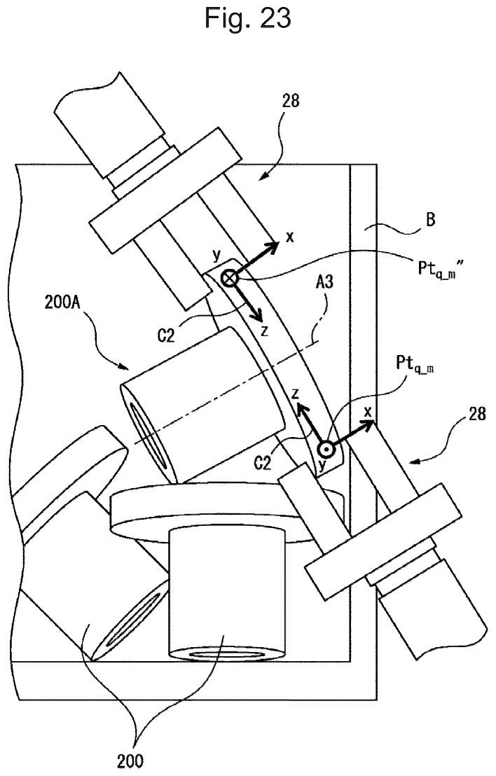

The symmetrical position Pt_{q_m}″ will be described with reference to FIG. 23. The example illustrated in FIG. 23 illustrates a case where the processor 32 determines interference for the target position Pt_{q_m} of the work on the workpiece 200A in the immediately preceding step S21, and determines as NO. When the end effector 28 is positioned at the target position Pt_{q_m}, the end effector 28 interferes with the container B and another workpiece 200.

Therefore, in this step S31, the processor 32 obtains the position of the central axis A3 with respect to the workpiece coordinate system C3 set in the search model 200Sₙ matched with the workpiece 200A in the most recent step S3 based on the position data B. Subsequently, based on the angle α, the processor 32 automatically determines a rotation angle α′ for rotating the target position Pt_{q_m} about the central axis A3 within a range of 0° to α.

In the present embodiment, since the angle α with respect to the workpiece model 200M is α=0° (or ∞) , the processor 32 automatically determines an arbitrary rotation angle α′ within the range of 0° to 360°. Subsequently, the processor 32 calculates a symmetrical position Pt_{q_m}″ obtained by rotating the target position Pt_{q_m} about the central axis A3 by the rotation angle α′. In the example of FIG. 23, the rotation angle α′ is determined as α′ =180°. Note that when the angle α is α=90° (i.e., the workpiece model has a regular quadrangular outer shape), the processor 32 automatically determines an arbitrary rotation angle α′ within the range of 0° to 90°. At this time, the processor 32 may determine the rotation angle α′=α=90°.

In this way, the processor 32 can obtain the symmetrical position Pt_{q_m}″ that is symmetrical to the target position Pt_{q_m} with respect to the central axis A3. Next, the processor 32 functions as the interference determining unit 72 and performs interference determination again with respect to the symmetrical position Pt_{q_m}″. When the end effector 28 is positioned at the symmetrical position Pt_{q_m}″, as illustrated in FIG. 23, the end effector 28 does not interfere with the container B and the other workpieces 200. Therefore, in this case, the processor 32 determines YES in step S31.

If determined that interference still occurs at the symmetrical position Pt_{q_m}″, the processor 32 newly determines a rotation angle α′ within the range of 0° to a (within the range of 0° to 360° when α=0°), calculates a new symmetrical position Pt_{q_m}″, and performs interference determination. In this way, the interference determination is performed every time the rotation angle α′ is selected within the range of 0° to a and the symmetrical position Pt_{q_m}″ is calculated, thereby searching for the symmetrical position Pt_{q_m}″ at which interference does not occur. On the other hand, in step S31, when the symmetrical position Pt_{q_m}″ at which the interference does not occur cannot be calculated, the processor 32 determines as NO, proceeds to step S22, and sequentially executes steps S22 to S24 described above.

In step S32, the processor 32 functions as the position correcting unit 74 and corrects the target position Pt_{q_m} subjected to the interference determination in the most recent step S21 to the symmetrical position Pt_{q_m}″ calculated in the immediately preceding step S31. Subsequently, the processor 32 proceeds to step S7 in FIG. 14, and in step S7, functions as the operation command unit 76 to control the robot 12 based on the symmetrical position Pt_{q_m}″, position the end effector 28 at the symmetrical position Pt_{q_m}″ as illustrated in FIG. 23, and execute the work on the workpiece 200A.

As described above, in the present embodiment, the information acquiring unit 78 acquires the symmetry information Im (position data β, information γ: angle α) related to the symmetry of the workpiece 200 (i.e., the workpiece model 200M). Subsequently, based on the symmetry information Im obtained by the information acquiring unit 78, the position correcting unit 74 corrects the target position Pt_{q_m} obtained by the position calculating unit 68 in step S4 to a position Pt_{q_m}″ symmetrical to the target position Pt_{q_m}.

Here, as in the present embodiment, when the work position Pwₘ is taught to the workpiece model 200M and the work position Pwₘ is shared among the plurality of search models 200Sₙ, interference as described in FIG. 23 is likely to occur when the target position Pt_{q_m} is obtained compared to when the work position Pwₘ is taught for each search model 200Sₙ. According to the present embodiment, when the work position Pwₘ is taught on the workpiece model 200M, the target position Pt_{q_m} can be corrected to the symmetrical position Pt_{q_m}″ using the symmetry information Im, and thus such interference can be effectively avoided.

Note that, in the flow of FIG. 22, the processor 32 may execute step S22 when determined as YES in step S21, and execute step S31 when determined as NO in step S22, similarly to the flow of FIG. 20. When determined as YES in step S31, step S32 may be executed, and when determined as NO, the process may proceed to step S24.

Note that the processor 32 may function as the input receiving unit 56 and receive the input of the symmetry information γ. For example, the operator operates the input device 40 to input at least one of the position data β of the central axis A3 (or symmetry axis) in the workpiece coordinate system C3, the adjustment amount λ for adjusting the position or direction of the central axis A3, and the angle α (or, the rotation angle α′).

The processor 32 functions as the input receiving unit 56 and receives the input H of the position data β, the adjustment amount λ, and the angle α. On the other hand, the processor 32 may update the position data β and the angle α acquired as the information acquiring unit 78 based on the position data β, the adjustment amount λ, and the angle α received from the operator, and register the updated position data β and the angle α as the symmetry information Im. In this case, the processor 32 may generate the image data of the GUI for receiving the input H of the position data, the adjustment amount 2, and the angle α. For example, the processor 32 may display this GUI in the search model setting image data 120 illustrated in FIG. 10.

Note that, in the above-described embodiment, the case where the device 60 includes the information acquiring unit 78 has been described, but the device 50 may have the function of the information acquiring unit 78. In this case, the processor 32 functions as the model arranging unit 52 in the teaching process described above, and reads the workpiece model 200M in response to the input operation to the model reading button image 108 illustrated in FIG. 4, and arranges the workpiece model at the virtual space VS.

At this time, the processor 32 may function as the information acquiring unit 78, analyze the model data of the workpiece model 200M, and acquire the symmetry information Im. In this case, the processor 32 may generate image data of a GUI for receiving the input H of the position data β, the adjustment amount λ, and the angle α from the operator, and display the image data in, for example, the teaching setting image data 100 illustrated in FIG. 4.

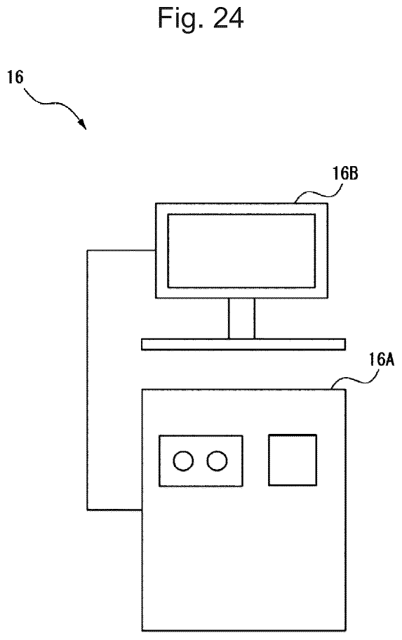

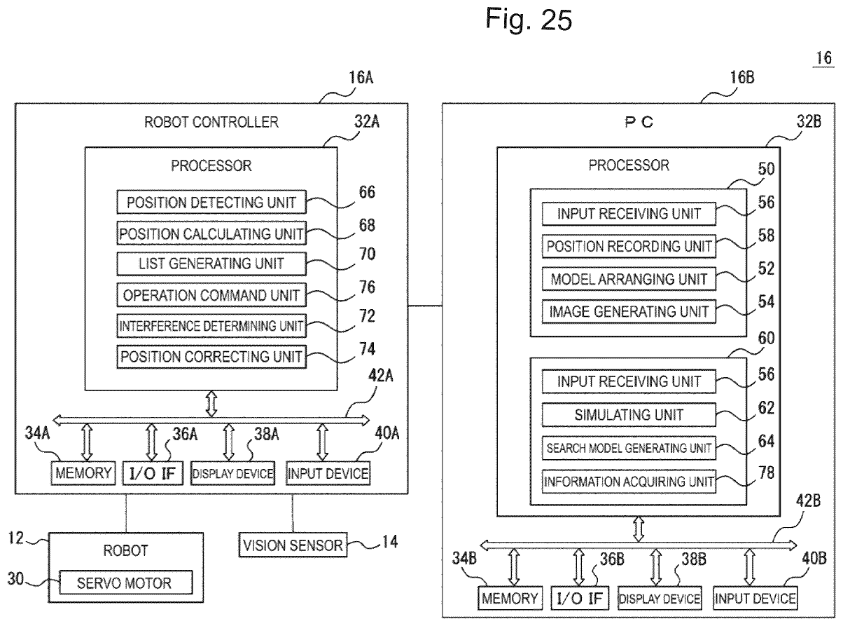

Note that the controller 16 may include at least two computers. Such a mode is illustrated in FIGS. 24 and 25. In the present embodiment, the controller 16 includes a robot controller 16A and a personal computer (PC) 16B. The robot controller 16A includes a processor 32A, a memory 34A, an I/O interface 36A, a display device 38A, an input device 40A, and the like. The PC 16B includes a processor 32B, a memory 34B, an I/O interface 36B, a display device 38B, an input device 40B, and the like. The I/O interfaces 36A and 36B are communicably connected to each other.

In the present embodiment, the functions of the devices 50 and 60 are implemented in the PC 16B, and the processor 32B executes the teaching process and the search model generation process described above. On the other hand, the functions of the position detecting unit 66, the position calculating unit 68, the list generating unit 70, the interference determining unit 72, and the position correcting unit 74 are implemented in the robot controller 16A, and the processor 32A executes the operation program OP_{A} to execute the flow of FIG. 14.

At least one of the functions (i.e., the model arranging unit 52, the image generating unit 54, the input receiving unit 56, the position recording unit 58, the information acquiring unit 78, the simulating unit 62, and the search model generating unit 64) of the devices 50 and 60 may be implemented in the robot controller 16A. Alternatively, at least one of the functions of the position detecting unit 66, the position calculating unit 68, the list generating unit 70, the interference determining unit 72, and the position correcting unit 74 may be implemented in the PC 16B.

In the above-described embodiment, the case has been described in which in step S3 in FIG. 14, the processor 32 acquires the coordinate Qd_{q} of the workpiece coordinate system C3 in the robot coordinate system C1 when the search model 200Sₙ is matched as the detection position Pd_{q}. However, the present invention is not limited thereto, and the processor 32 may acquire the coordinates of the workpiece coordinate system C3 in the user coordinate system C4 set in the robot coordinate system C1 as the detection position Pd_{q}. The user coordinate system C4 is, for example, the control coordinate system C set at an arbitrary position (such as a corner of the container B) of the robot coordinate system C1 by the operator.

In this case, in step S4 in FIG. 14, the processor 32 may acquire the target position Pt_{q_m} as coordinates of the user coordinate system C4, and convert the coordinates in the user coordinate system C4 into coordinates in the robot coordinate system C1 when executing step S7. Note that in steps S3 and S4, the processor 32 may acquire the detection position Pd_{q} and the target position Pt_{q_m} as coordinates of any control coordinate system C other than the user coordinate system C4.

The present disclosure has been described in detail thus far, but the present disclosure is not limited to the individual embodiments. Various additions, replacements, changes, partial deletions, and the like can be made to these embodiments without departing from the gist of the present disclosure or without departing from the gist of the present disclosure derived from the contents described in the claims and equivalents thereof. Further, these embodiments can also be combined and implemented. For example, in the above-described embodiment, the order of the operations and the order of the processes are given as examples, and are not limited thereto. The same applies to a case where a numerical value or a mathematical expression is used in the description of the above-described embodiment.

The present disclosure discloses the following aspects.

(Aspect 1) A device 60 configured to generate a search model 200Sₙ for searching for a workpiece 200 from image data 140 obtained by imaging the workpiece 200, the device 60 including: an input receiving unit 56 configured to receive an input of a change amount θ for changing an orientation of a workpiece model 200M modeling the workpiece 200 in a virtual space VS, a simulating unit 62 configured to simulatively change the orientation of the workpiece model 200M in the virtual space VS in accordance with the change amount θ received by the input receiving unit 56, and a search model generating unit 64 configured to generate the search model 200Sₙ representing a shape of the workpiece model 200M viewed from a predetermined viewpoint VP in the virtual space VS based on the workpiece model 200M when the simulating unit 62 changes the orientation.

(Aspect 2) The device 60 according to aspect 1, wherein the input receiving unit 56 receives an input of an angle θ for rotating the workpiece model 200M about an axis (x axis, y axis, z axis) of a coordinate system C (workpiece coordinate system C3) set in the virtual space VS as the change amount θ, the simulating unit 62 repeatedly executes the simulative rotation operation VR for rotating the workpiece model 200M about the axis by the angle θ to change the orientation, and the search model generating unit 64 generates the search model 200Sₙ every time the simulating unit 62 executes the simulative rotation operation VR.

(Aspect 3) The device 60 according to aspect 2, wherein the simulating unit 62 executes the first simulative rotation operation VRₓ of rotating the workpiece model 200M about the first axis (x axis, y axis of the workpiece coordinate system C3) and the second simulative rotation operation VR_{z} of rotating the workpiece model about the second axis (z-axis of the workpiece coordinate system C3) orthogonal to the first axis.

(Aspect 4) The device 60 of any one of aspects 1 to 3, wherein the workpiece has symmetry, and the device 60 further includes an information acquiring unit 78 configured to acquire symmetry information Is related to the symmetry.

(Aspect 5): A controller 16 including: the device 60 of any one of Aspects 1 to 4, and a position detecting unit 66 configured to acquire a position Pd of the workpiece 200 appearing in the image data 140 by searching for the workpiece 200 appearing in the image data 140 using the search model 200Sₙ generated by the search model generating unit 64.

(Aspect 6) A method of generating a search model 200Sₙ for searching for a workpiece 200 from image data 140 obtained by imaging the workpiece 200, wherein a processor 32 is configured to receive an input of a change amount θ for changing an orientation of a workpiece model 200M modeling the workpiece 200 in a virtual space VS, simulatively change the orientation of the workpiece model 200M in the virtual space VS in accordance with the received change amount θ, and generate a search model 200Sₙ representing a shape of the workpiece model 200M viewed from a predetermined viewpoint VP in the virtual space VS based on the workpiece model 200M when the orientation is changed.

(Aspect 7): A device 50 for teaching a work position Pw at which a robot 12 carries out a work on a workpiece 200, the device 50 including: an input receiving unit 56 configured to receive an input F (Fm, Fr) for teaching the work position Pw on a workpiece model 200M modeling an overall shape of the workpiece 200, and a position recording unit 58 configured to record the work position Pw taught in response to the input F received by the input receiving unit 56 in association with the workpiece model 200M as a teaching position PWₜ (coordinate Qw) indicating a positional relationship between the workpiece model 200M and the work position Pw, the recorded teaching position Pwₜ being used to calculate the work position Pw on the workpiece 200 searched from the image data 140 by a search model 200Sₙ generated based on the workpiece model 200M.

(Aspect 8) The device 60 according to aspect 7, further including: a model arranging unit 52 configured to arrange at least one of a robot model 12M modeling the robot 12 and a control coordinate system C (robot coordinate system C1, tool coordinate system C2, and workpiece coordinate system C3) for controlling the robot 12, and the workpiece model 200M at the virtual space VS, and an image generating unit 54 configured to generate the image data 110 of the virtual space VS in which the workpiece model 200M and the at least one of the robot model 12M and the control coordinate system C are arranged, wherein the input receiving unit 56 receives, as the input F for teaching, an input Fm that simulatively moves the at least one of the robot model 12M and the control coordinate system C in the virtual space VS.

(Aspect 9): The device 60 according to aspect 8, wherein the robot 12 includes the end effector 28 configured to carry out a work on the workpiece 200, the control coordinate system C includes a tool coordinate system C2 that determines a position of the end effector 28, the model arranging unit 52 places an end effector model 28M modeling the end effector 28 and the tool coordinate system C2 at the virtual space VS, and the input receiving unit 56 receives, as the input Fm for moving, an input Fmₜ (Fmₜ₁, Fmₜ₂, Fmₜ₃) that translationally moves the end effector model 28M such that the origin of the tool coordinate system C2 is displaced or an input Fmᵣ (Fmᵣ₁, Fmᵣ₂, Fmᵣ₃) that rotationally moves the end effector model 28M about an axis (x axis, y axis, z axis) of the tool coordinate system C2.

(Aspect 10) The device 60 according to aspect 9, wherein the image generating unit 54 further displays a movement selection button image 112 for selecting translational movement or rotational movement in the image data 110, and the input receiving unit 56 is capable of receiving the input Fmₜ for translational movement when translational movement is selected by the movement selection button image 112, and is capable of receiving the input Fmᵣ for rotational movement when rotational movement is selected by the movement selection button image 112.

(Aspect 11): A controller 16 including: the device 60 of any one of aspects 7 to 10, a position detecting unit 66 configured to acquire a position of the workpiece 200 appearing in the image data 140 as a detection position Pd_{q} (coordinates Qd_{q}) by searching for the workpiece 200 appearing in the image data 140 using a search model 200Sₙ, and a position calculating unit 68 configured to obtain, by calculation, a work position Pwₘ on the workpiece 200, the detection position Pd_{q} of which is detected, as a target position Pt_{q_m}, based on the teaching position Pwₜₘ recorded by the position recording unit 58 and the detection position Pd_{q} acquired by the position detecting unit 66.

(Aspect 12) The controller 16 according to aspect 11, further including a list generating unit 70 configured to generate list data 150 in which the plurality of target positions Pt_{q_m} obtained by the position calculating unit 68 are lined up in the form of a list.

(Aspect 13): The controller 16 according to aspect 12, wherein the input receiving unit 56 further receives an input G that determines a priority order of the taught work position Pwₘ, the list generating unit 70 generates the list data 150 in which the plurality of target positions Pt_{q_m} are lined up in accordance with the priority order received by the input receiving unit 56, and the controller 16 further includes an operation command unit 76 configured to control the robot 12 based on the target position Pt_{q_m} having the highest priority order in the list data 150 and position the robot 12 at the highest-order target position Pt_{q_m} to execute the work.

(Aspect 14): The controller 16 according to aspect 13, further including an interference determining unit 72 configured to determine whether or not interference occurs between the robot 12 and an environmental object E when the robot 12 is positioned at the target position Pt_{q_m}, wherein the interference determining unit 72 sequentially performs interference determination on the plurality of target positions Pt_{q_m} included in the list data 150 in accordance with the priority order, and the operation command unit 76 controls the robot 12 based on the highest-order target position Pt_{q_m} determined that the interference does not occur by the interference determining unit 72, among the plurality of target positions Pt_{q_m} included in the list data 150.

(Aspect 15) The controller 16 of any one of aspects 11 to 14, wherein the overall shape has symmetry, and the controller 16 further includes a position correcting unit 74 configured to correct the target position Pt_{q_m} obtained by the position calculating unit 68 to a position Pt_{q_m}″ that is symmetrical to the target position Pt_{q_m} based on symmetry information Is regarding the symmetry.

(Aspect 16) A method of teaching a work position Pw at which a robot 12 carries out a work on a workpiece 200, wherein a processor 32 is configured to receive an input F (Fm, Fr) for teaching the work position Pw to a workpiece model 200M modeling an overall shape of the workpiece 200, record a taught work position Pw in response to the received input F, as a teaching position Pwₜ (coordinates Qw), in association with the workpiece model 200M, wherein the work position Pw on the workpiece 200 searched for from the image data 140 by a search model 200Sₙ generated based on the workpiece model 200M is to be calculated using the recorded teaching position Pwₜ.

### REFERENCE SIGNS LIST

10 Robot system
12 Robot
14 Vision sensor
16 Controller
32 Processor
50, 60, Device
52 Model arranging unit
54 Image generating unit
56 Input receiving unit
58 Position recording unit
62 Simulating unit
64 Search model generating unit
66 Position detecting unit
68 Position calculating unit
70 List generating unit
72 Interference determining unit
74 Position correcting unit
76 Operation command unit
78 Information acquiring unit

1. A device configured to generate a search model for searching for a workpiece from image data obtained by imaging the workpiece, the device comprising:
an input receiving unit configured to receive an input of a change amount for changing an orientation of a workpiece model modeling the workpiece in a virtual space;
a simulating unit configured to simulatively change the orientation of the workpiece model in the virtual space in accordance with the change amount received by the input receiving unit; and
a search model generating unit configured to generate, based on the workpiece model, the search model representing a shape of the workpiece model as viewed from a predetermined viewpoint in the virtual space, when the simulating unit changes the orientation.

2. The device of claim 1, wherein the input receiving unit is configured to receive, as the change amount, an input of an angle for rotating the workpiece model about an axis of a coordinate system set in the virtual space;
wherein the simulating unit is configured to change the orientation, by repeatedly executing a simulative rotation operation to rotate the workpiece model about the axis by the angle; and
wherein the search model generating unit is configured to generate the search model every time the simulating unit executes the simulative rotation operation.

3. The device of claim 2, wherein the simulating unit is configured to execute:
a first simulative rotation operation to rotate the workpiece model about a first axis, and
a second simulative rotation operation to rotate the workpiece model about a second axis orthogonal to the first axis.

4. The device of claim 1, wherein the workpiece has symmetry, and
wherein the device further comprises an information acquiring unit configured to acquire symmetry information regarding the symmetry.

5. A controller comprising:
the device of claim 1; and
a position detecting unit configured to acquire a position of the workpiece appearing in the image data, by searching for the workpiece appearing in the image data using the search model generated by the search model generating unit.

6. A method of generating a search model for searching for a workpiece from image data obtained by imaging the workpiece, the method comprising:
receiving, by a processor, an input of a change amount for changing an orientation of a workpiece model modeling the workpiece in a virtual space;
simulatively changing, by the processor, the orientation of the workpiece model in the virtual space, in accordance with the received change amount; and
generating, by the processor, the search model representing a shape of the workpiece model as viewed from a predetermined viewpoint in the virtual space, based on the workpiece model, when the orientation is changed.

7. A device configured to teach a work position at which a robot carries out a work on a workpiece, the device comprising:
an input receiving unit configured to receive an input for teaching the work position on a workpiece model modeling an overall shape of the workpiece; and
a position recording unit configured to record the work position, which is taught in response to the input received by the input receiving unit, in association with the workpiece model, as a teaching position indicating a positional relationship between the workpiece model and the work position, wherein the work position on the workpiece searched from image data by a search model generated based on the workpiece model is to be calculated using the recorded teaching position.

8. The device of claim 7, further comprising:
a model arranging unit configured to arrange at least one of a robot model modeling the robot and a control coordinate system for controlling the robot, and the workpiece model in a virtual space; and
an image generating unit configured to generate image data of the virtual space in which the workpiece model and the at least one of the robot model and the control coordinate system are arranged,
wherein the input receiving unit is configured to receive, as the input for teaching, an input for simulatively moving the at least one of the robot model and the control coordinate system in the virtual space.

9. The device of claim 8, wherein the robot includes an end effector configured to carry out the work on the workpiece,
wherein the control coordinate system includes a tool coordinate system that defines a position of the end effector,
wherein the model arranging unit is configured to arrange an end effector model modeling the end effector and the tool coordinate system in the virtual space, and
wherein the input receiving unit is configured to receive, as the input for simulatively moving:
an input for causing a translational movement of the end effector model such that an origin of the tool coordinate system is displaced; or
an input for causing a rotational movement of the end effector model about an axis of the tool coordinate system.

10. The device of claim 9, wherein the image generating unit further displays a movement selection button image for selecting the translational movement or the rotational movement in the image data, and
wherein the input receiving unit is:
capable of receiving the input of the translational movement when the translational movement is selected by the movement selection button image; while
capable of receiving the input of the rotational movement when the rotational movement is selected by the movement selection button image.

11. A controller comprising:
the device of claim 7;
a position detecting unit configured to acquire a position of the workpiece appearing in the image data as a detection position, by searching for the workpiece appearing in the image data using the search model; and
a position calculating unit configured to obtain, by calculation, the work position on the workpiece, the detection position of which is detected, as a target position, based on the teaching position recorded by the position recording unit and the detection position acquired by the position detecting unit.

12. The controller of claim 11, further comprising a list generating unit configured to generate list data in which a plurality of the target positions obtained by the position calculating unit are lined up in the form of a list.

13. The controller of claim 12, wherein the input receiving unit is configured to further receive an input for determining a priority order of the taught work position,
wherein the list generating unit is configured to generate the list data in which the plurality of target positions are lined up in accordance with the priority order received by the input receiving unit, and
wherein the controller further includes an operation command unit configured to control the robot based on the target position having the highest priority order in the list data, and position the robot at the highest-order target position to carry out the work.

14. The controller of claim 13, further comprising an interference determining unit configured to determine whether or not interference occurs between the robot and an environmental object when the robot is positioned at the target position,
wherein the interference determining unit is configured to sequentially determine the interference for the plurality of target positions included in the list data in accordance with the priority order, and
wherein the operation command unit is configured to control the robot based on the highest-order target position, at which the interference determining unit determines that the interference does not occur, among the plurality of target positions included in the list data.

15. The controller of claim 11, wherein the overall shape has symmetry, and
wherein the controller further comprises a position correcting unit configured to correct the target position obtained by the position calculating unit to a position that is symmetrical to the target position, based on symmetry information regarding the symmetry.

16. A method of teaching a work position at which a robot carries out work on a workpiece, the method comprising:
receiving, by a processor, an input for teaching the work position on a workpiece model modeling an overall shape of the workpiece; and
recording, by the processor, the work position, which is taught in response to the received input, in association with the workpiece model, as a teaching position indicating a positional relationship between the workpiece model and the work position,
wherein the work position on the workpiece searched from the image data by a search model generated based on the workpiece model is to be calculated using the recorded teaching position.
